(19) United States
(12) Patent Application Publication
(10) Pub. No.: US 2012/0095613 A1
(43) Pub. Date: Apr. 19, 2012

(54) COMMUNICATION DEVICE, POWER DISTRIBUTION CONTROL DEVICE, AND POWER DISTRIBUTION CONTROL SYSTEM

(75) Inventor: Shinichiro Tsuda, Kanagawa (JP)

(73) Assignee: SONY CORPORATION, Tokyo (JP)

(21) Appl. No.: 13/251,387

(22) Filed: Oct. 3, 2011

(30) Foreign Application Priority Data
Oct. 15, 2010 (JP) P2010-232219
Aug. 11, 2011 (JP) P2011-175573

(51) Int. Cl. G06F 1/28; G06F 1/26

(52) U.S. Cl. 700/297

(57) ABSTRACT

A communication device, which communicates with a power distribution control device which controls power distribution with regard to a region which is a power distribution target, includes an acquisition unit which acquires calculation information for calculating electrical power which is to be distributed with regard to the region, and a transmission unit which transmits the calculation information to the power distribution control device.

### CROSS-REFERENCE TO RELATED APPLICATION

The present application claims priority from Japanese Patent Application Nos. JP 2010-232219 and JP 2011-175573 filed in the Japanese Patent Office on Oct. 15, 2010 and Aug. 11, 2011, respectively, the entire contents of which are incorporated herein by reference.

### BACKGROUND

The present disclosure relates to a communication device, a power distribution control device, and a power distribution control system, and in particular, relates to a communication device, a power distribution control device, and a power distribution control system which make appropriate power distribution possible to perform by, for example, tracking variation in electrical power which is necessary for each of a plurality of regions.

At this time, in power plants in Japan, the demand for electrical power which is necessary for typical households and the like is predicted and electrical power is supplied at a supply amount in accordance with the predicted demand. Then, based on the predicted demand for electrical power, power distribution is performed at a voltage value within a range of, for example, 95 V to 107 V in relation to single phase 100 V, by adjusting for a transformation ratio and the like when the electrical power is supplied to the typical households and the like.

Here, in Japanese Unexamined Patent Application Publication No. 2010-57311, a voltage maintenance technique is proposed where the voltage value of the electrical power which is distributed is maintained within a predetermined range in collaboration with each power plant.

In addition, in recent years, smart grid technology where electrical power is efficiently supplied to typical households and the like from power plants has attracted attention mainly in North America. According to the smart grid technology, it is possible to dynamically change the supply of electrical power from power plants according to the demand for electrical power by typical households and the like by utilizing high-performance IT technology.

Furthermore, in combination with the problem of global warming due to CO2 and the like, attempts to utilize solar panels which generate power by receiving light such as sunlight and storage batteries which store electrical energy in typical households and the like as a supply source of electrical power in an auxiliary manner is spreading to each region in the world. As a result, even in typical households in Japan, the utilization of solar panels and the like in an auxiliary manner is being carried out.

### SUMMARY

As described above, as a result of the carrying out of utilization of solar panels and the like in an auxiliary manner even in typical households in Japan, demand for electrical power which is to be supplied from the power plants varies largely and the predicting of demand for electrical power is more difficult.

If it is assumed that there is a case where demand for electrical power is erroneously predicted, the balance between electrical power which is actually necessary and electrical power which is supplied by the power plants will break down. In this case, the frequency of AC current which flows in the transmission lines varies. As a result, there is a phenomenon where there is a power swing in a turbine for power generating in a power plant and stoppage or breakage of equipment such as a turbine may occur.

In addition, for example, in a case where demand for electrical power is erroneously predicted, since the transformation ratio is adjusted based on the demand for electrical power which is erroneously predicted, it may not be possible to perform power distribution to typical households at a voltage value within the range of 95 V to 107 V.

It is desirable to perform appropriate power distribution by tracking variation in electrical power which is necessary.

A communication device according to the first embodiment of the disclosure is a communication device which communicates with a power distribution control device which controls power distribution with regard to a region which is a power distribution target and includes an acquisition unit which acquires calculation information for calculating electrical power which is to be distributed with regard to the region and a transmission unit which transmits the calculation information to the power distribution control device.

The acquisition unit may calculate and acquire a composite value of impedance of a load which consumes electrical power in a predetermined space which is provided in a region as the calculation information and the transmission unit may transmit the composite value to the power distribution control device.

The acquisition unit may calculate a composite value of impedance of a load which has its power on out of a plurality of loads which exist in the predetermined space and may calculate the composite value using the impedance obtained based on an operation mode of the load with regard to loads where the impedance changes in accordance with the operation of the load.

In a case where a function which expresses the AC current flowing in the load changes over a predetermined cycle, the acquisition unit may calculate the impedance of the load for each AC current which is expressed using the same function and may calculate the composite value using a plurality of calculated impedances.

A determination unit, which determines whether or not a user exists in the predetermined space, and a history information holding unit, which holds information on the loads in cases where the user exists in the predetermined space and information on the loads in cases where the user does not exist in the predetermined space as past history information, may be further provided, and the acquisition unit may calculate the composite value of the impedance of the loads using the history information held in the history information holding unit based on the determination result of whether or not the user exists in the predetermined space.

The acquisition unit may calculate a composite value which expresses the impedance of all of the plurality of loads using a table where the impedance of the loads correspond to each of the plurality of loads.

A power source unit, which generates its own power which is consumed by the load, and a detection unit, which detects the amount of electrical power of the electrical power generated by the power source unit and consumed by the load, may be further provided, and the transmission unit may transmit the composite value and the amount of electrical power to the power distribution control device.

The power source unit may be formed by at least one of a power storage unit which generates electrical power which has been stored and a power generating unit which generates electrical power by generating power.

The power storage unit may store electrical power obtained by generating power.

The acquisition unit may acquire identification information for uniquely identifying the loads which consume electrical power in the predetermined space as the calculation information and the transmission unit may transmit the identification information to the power distribution control device.

The acquisition unit may acquire the identification information and mode information which shows an operation mode of the load as the calculation information and the transmission unit may transmit the identification information and the mode information to the power distribution control device.

According to the first embodiment of the disclosure, calculation information for calculating the electrical power which is to be distributed with regard to the region is acquired and the acquired calculation information is transmitted to the power distribution control device.

A power distribution control device according to a second embodiment of the disclosure is a power distribution control device which controls power distribution with regard to a region which is a power distribution target and includes a reception unit which receives calculation information for calculating electrical power which is to be distributed to the region from a communication device which communicates with the power distribution control device, a power calculation unit which calculates the electrical power which is to be distributed to the region based on the received calculation information, and a power distribution control unit which performs power distribution with regard to the region based on the calculated electrical power.

The power calculation unit may calculate the electrical power which is to be distributed to each of a plurality of regions and the power distribution control unit may partition or amalgamate the regions which are power distribution targets based on the electrical power which is to be distributed to each of the plurality of regions and may perform power distribution with regard to the regions after partition or amalgamation.

The reception unit may receive a composite value of impedance of a load which consumes electrical power in a predetermined space which is provided in a region as the calculation information and the power calculation unit may calculate the electrical power which is to be distributed with regard to the region based on the received composite value.

The reception unit may receive an amount of electrical power which is generated by the communication device itself as the calculation information and the power calculation unit may calculate the electrical power which is to be distributed with regard to the region based on the received composite value and the amount of electrical power.

There may be loads which consume electrical power in the predetermined space provided in the region, a history information holding unit, which holds information on the loads in cases where a user exists in the predetermined space and information on the loads in cases where a user does not exist in the predetermined space as past history information, may be further provided, the reception unit may receive location information which shows whether or not the user exists in the predetermined space, and the power calculation unit may calculate the electrical power which is to be distributed with regard to the region using the history information which is held by the history information holding unit based on the received location information.

The reception unit may receive identification information for uniquely identifying the loads which consume electrical power in the predetermined space provided in the region as the calculation information, a holding unit, which holds the impedance of the loads which correspond to the identification information in advance, and a composite value calculation unit, which calculates the composite value of the impedance of the loads by referencing the holding unit based on the received identification information, may be further provided, and the power calculation unit may calculate the electrical power which is to be distributed with regard to the region based on the calculated composite value.

The holding unit may hold the impedance of the loads which are operated using an operation mode in advance so that the identification information of the loads and the mode information which shows the operation mode of the loads correspond, the reception unit may receive the identification information and the mode information as the calculation information, and the composite value calculation unit may calculate the composite value of the impedance of the loads by referencing the holding unit based on the received identification information and mode information.

The power distribution control unit may perform power distribution with regard to the region by controlling at least one of a transformer which transforms the voltage of the voltage when distributing power to the region and a reactive electrical power control device which controls reactive electrical power when distributing power to the region, based on the calculated electrical power.

According to the second embodiment of the disclosure, calculation information for calculating electrical power which is to be distributed to the region is received from a communication device which communicates with the power distribution control device, electrical power which is to be distributed to the region is calculated based on the received calculation information, and power distribution with regard to the region is performed based on the calculated electrical power.

A power distribution control system according to a third embodiment of the disclosure is a power distribution control system which is configured from a power distribution control device which controls power distribution with regard to a region which is a power distribution target and a communication device which communicates with the power distribution control device where the communication device includes an acquisition unit which acquires calculation information for calculating electrical power which is to be distributed with regard to the region and a transmission unit which transmits the calculation information to the power distribution control device and the power distribution control device includes a reception unit which receives calculation information for calculating electrical power which is to be distributed to the region from the communication device, an power calculation unit which calculates the electrical power which is to be distributed to the region based on the received calculation information, and a power distribution control unit which performs power distribution with regard to the region based on the calculated electrical power.

According to the third embodiment of the disclosure, calculation information for calculating the electrical power which is to be distributed with regard to the region is acquired and the acquired calculation information is transmitted to the power distribution control device using the communication device, and the calculation information is received from the communication device, electrical power which is to be distributed to the region is calculated based on the received calculation information, and power distribution with regard to the region is performed based on the calculated electrical power.

According to the first embodiment of the disclosure, it is possible to transmit necessary information for performing power distribution by tracking variation in electrical power which is necessary.

According to the second embodiment of the disclosure, it is possible to perform appropriate power distribution by tracking variation in electrical power which is necessary.

According to the third embodiment of the disclosure, it is possible to transmit necessary information for performing power distribution by tracking variation in electrical power which is necessary and to perform appropriate power distribution by tracking variation in electrical power which is necessary.

### BRIEF DESCRIPTION OF THE DRAWINGS

FIG. 1 is a block diagram illustrating a configuration example of a power distribution control system according to an embodiment of the disclosure;

FIG. 2 is a block diagram illustrating a configuration example of a communication device according to a first embodiment;

FIG. 3 is a diagram illustrating an example of a table where impedance of a device corresponds to each device ID;

FIG. 4 is a flowchart for describing an impedance transmission process which is performed by the communication device in FIG. 2;

FIG. 5 is a block diagram illustrating a configuration example of a power distribution control device according to the first embodiment;

FIG. 6 is a flowchart for describing a first control process which is performed by the power distribution control device in FIG. 5;

FIG. 7 is a diagram illustrating an example of a table where impedance of a device corresponds to each combination of device ID and mode ID;

FIG. 8 is a block diagram illustrating another configuration example of a communication device according to the first embodiment;

FIG. 9 is a block diagram illustrating a configuration example of a communication device according to a second embodiment;

FIG. 10 is a flowchart for describing an ID transmission process which is performed by the communication device in FIG. 9;

FIG. 11 is a block diagram illustrating a configuration example of a power distribution control device according to the second embodiment;

FIG. 12 is a flowchart for describing a second control process which is performed by the power distribution control device in FIG. 11;

FIG. 13 is a block diagram illustrating a configuration example of a communication device according to a third embodiment;

FIG. 14 is a flowchart for describing a generation amount transmission process which is performed by the communication device in FIG. 13;

FIG. 15 is a block diagram illustrating a configuration example of a power distribution control device according to the third embodiment;

FIG. 16 is a flowchart for describing a third control process which is performed by the power distribution control device in FIG. 15;

FIG. 17 is a diagram illustrating an example of a voltage value of electrical power which is supplied to a house from a power plant via a transformer;

FIG. 18 is a block diagram illustrating an example of a voltage value when electrical power is output from a house to transmission lines in order to sell power;

FIG. 19 is a block diagram illustrating a configuration example of a power distribution control device according to a fourth embodiment;

FIG. 20 is a flowchart for describing a region setting process which is performed by the power distribution control device in FIG. 19;

FIG. 21 is a block diagram illustrating a configuration example of a communication device according to a fifth embodiment;

FIG. 22 is a flowchart for describing an at-home information transmission process which is performed by the communication device in FIG. 21;

FIG. 23 is a block diagram illustrating a configuration example of a power distribution control device according to the fifth embodiment;

FIG. 24 is a flowchart for describing a fourth control process which is performed by the power distribution control device in FIG. 23;

FIG. 25 is a diagram illustrating an example of a current and a voltage;

FIG. 26 is a diagram illustrating an example of a case where a current and a voltage are expressed using polar coordinates;

FIG. 27 is a diagram illustrating an example of a case where impedance is calculated for each partitioned section;

FIG. 28 is a block diagram illustrating a configuration example of a dispersed power source;

FIG. 29 is a block diagram illustrating another configuration example of a dispersed power source; and

FIG. 30 is a block diagram illustrating a configuration example of a computer.

### DETAILED DESCRIPTION OF EMBODIMENTS

Below, embodiments of the disclosure will be described. Here, the description will be performed in the order below.

1. First Embodiment (Example when Power Distribution is Controlled by Power Distribution Control Device based on Composite Value of Impedance from Communication Device)

2. Modified Example of First Embodiment

3. Second Embodiment (Example when Power Distribution is Controlled by Power Distribution Control Device based on Device ID and Mode ID from Communication Device)

4. Third Embodiment (Example when Power Distribution is Controlled by Power Distribution Control Device based on Device ID, Mode ID, and Power Generation Amount from Communication Device)

5. Fourth Embodiment (Example when Power Distribution Control Device Amalgamates or Partitions Region which is Power Distribution Target)

6. Fifth Embodiment (Example when Power Distribution is Controlled by Power Distribution Control Device based on whether User is At Home in a House)

7. Sixth Embodiment (Example when Impedance is Calculated using Voltage Value and Current Value)

8. Modified Examples

<1. First Embodiment>

[Configuration of Power Distribution Control System 1]

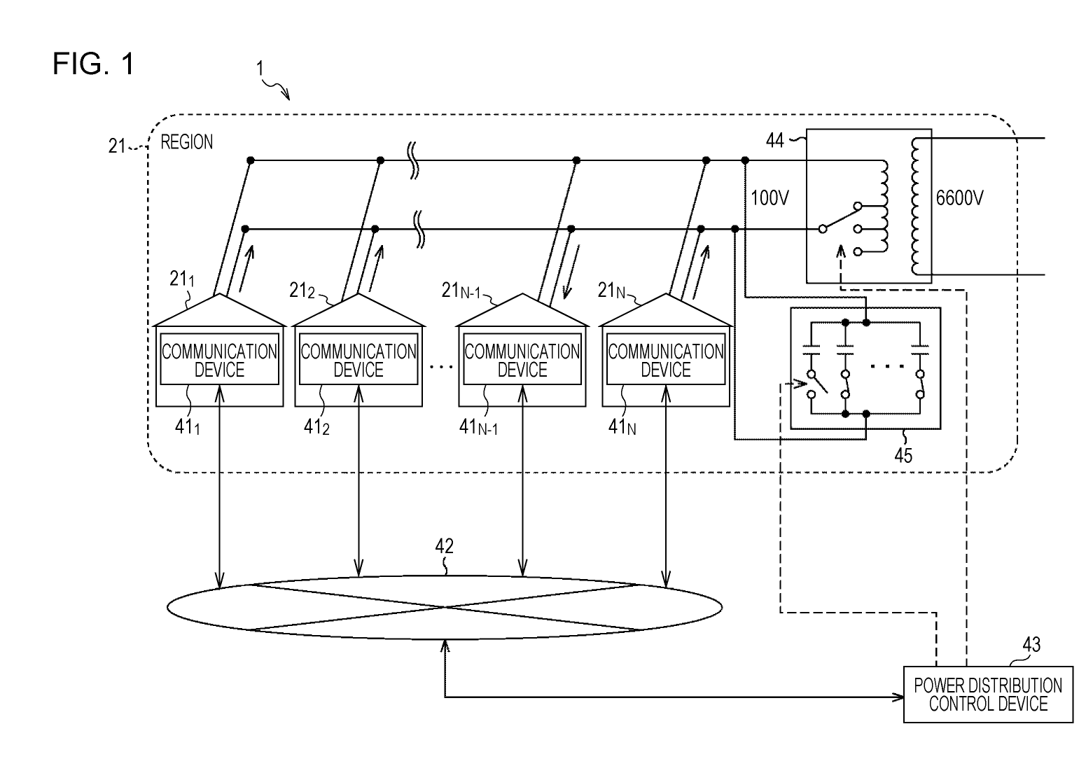

FIG. 1 illustrates a configuration example of a power distribution control system 1 according to an embodiment of the disclosure.

Here, for example, the power distribution control system 1 supplies (distributes) electrical power which is necessary for a region 21 in accordance to demand for electrical power which is necessary in the region 21 which is the power distribution target. Here, in the region 21, for example, respective households 211 to 21N which consume electrical power using electrical appliances are included. In addition, as the electrical power supplied to the respective households 211 to 21N, single phase 100 V, single phase 200 V, three phase 200 V, and the like are used, but in the embodiments below, for convenience sake, the description will be performed with single phase 100 V. As such, this does not mean that the embodiments are limited to single phase 100 V.

The power distribution control system 1 is configured from the households 211 to 21N, communication devices 411 to 41N which are provided in the respective households, a network 42, a power distribution control device 43, a transformer 44, and a reactive power control device 45.

The communication device 411 supplies calculation information (for example, the composite value of the impedance of the electrical appliances, device IDs for identifying the electrical appliances, and the like), which is necessary for calculating the electrical power which is consumed by the electrical appliances and the like which are provided in the household 211, to the power distribution control device 43 via the network 42.

Here, the communication devices 412 to 41N are each configured in the same manner as the communication device 411, and thus, the description of these is omitted.

The network 42 is, for example, the Internet or the like, and connects the communication devices 411 to 41N and the power distribution control device 43 to each other in a wired, wireless, or other manner.

The power distribution control device 43 calculates the electrical power which is necessary in the region 21 (referred to below as power demand) based on the calculation information which is supplied from the communication devices 412 to 41N via the network 42, and controls the transformer 44 and the reactive power control device 45 according to the calculation result.

The transformer 44 transforms (for example, transforms 6600 V to 100 V) the voltage of the electrical power which is supplied via transmission lines from a power plant by a predetermined transformation ratio in accordance with control from the power distribution control device 43 and supplies the electrical power after transformation to the respective households 211 to 21N.

The reactive power control device 45 adjusts the amount of electrical power which is reactive power which flows on the transmission lines in accordance with control from the power distribution control device 43. Here, reactive power is electrical power which is not consumed by the load of the electrical appliances and the like which are provided in the respective households 211 to 21N and is electrical power which only goes back and forth between the electrical power transmitting side and the receiving side.

Accordingly, the reactive power is consumed as heat energy due to resistance components in the transmission lines in the process of going back and forth between the transmitting side and the receiving side.

Here, the reactive power is generated by an inductance component of the transmission lines and a reactance component which accompanies the load of the electrical appliances and the like which are provided in the respective households 211 to 21N and reduces the power factor. Here, the power factor expresses the phases difference θ of the AC current on the transmission lines and the AC voltage using cos θ.

[First Configuration Example of Communication Device 41n]

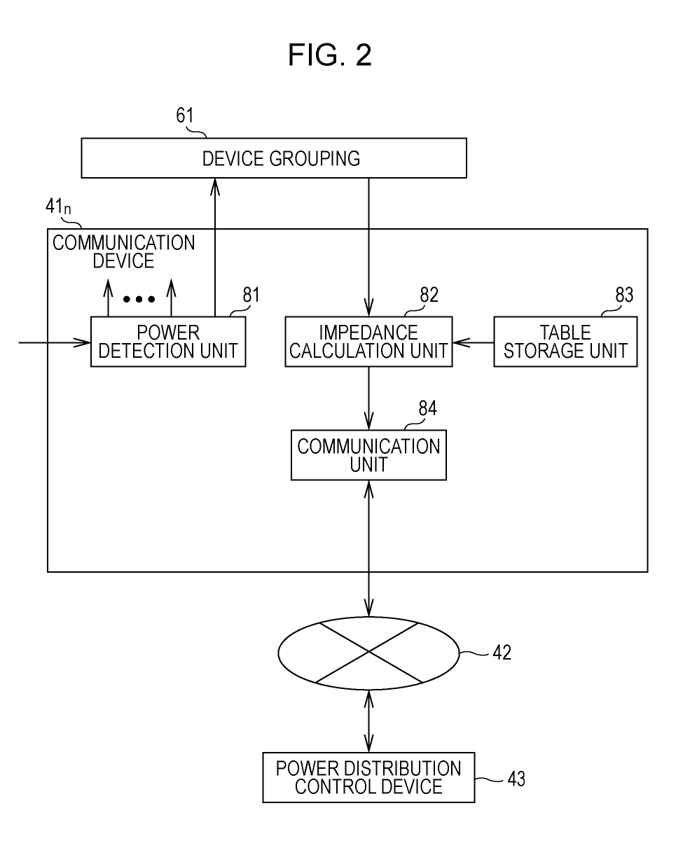

Next, FIG. 2 illustrates a configuration example of a communication device 41n which is provided in the household 21n (where n=1, 2, . . . , N−1, N). Here, the communication device 41n is connected to an AC power source (power socket) which is provided in the household 21n and acquires electrical power from the transmission lines which is drawn into the household 21n via the AC power source. Then, the communication device 41n is operated based on the acquired electrical power and connects to a device grouping 61 which is configured by the electrical appliances and the like provided in the household 21n via electrical power wiring.

The communication device 41n is configured from a power detection unit 81, an impedance calculation unit 82, a table storage unit 83, and a communication unit 84.

The power detection unit 81 is connected to the AC power source in the household 21n via the electrical power wiring and supplies electrical power from the AC power source to the impedance calculation unit 82, the table storage unit 83, and the communication unit 84 in the communication device 41n and to the device grouping 61.

In addition, the power detection unit 81 detects the amount of electrical power of the power consumption which supplied to the device grouping 61 from the AC power source and is consumed and displays the amount of electrical power on a display device or the like (not shown) which is provided outside of the household 21n. Then, at the electrical power company, the amount of electrical power which is displayed on the display device is confirmed, for example, once a month, and a request for electrical power fees are performed from the electrical power company with regard to the residents living in the household 21n based on the confirmed items.

The impedance calculation unit 82 acquires a device ID for each of the electrical appliances which configure the device grouping 61 which is connected in the communication device 41n. Here, the device ID is acquired by the device IDs of the device grouping 61 which is connected in the communication device 41n being, for example, input by a user using an operational unit (not shown) which is provided in the communication device 41n.

In addition, the impedance calculation unit 82 reads out an impedance which corresponds to the respective device IDs of each of the electrical appliances which configure the device grouping 61 from a table which is stored in the table storage unit 83. Here, the impedance calculation unit 82 calculates a composite value which expresses the impedance of the entire device grouping 61 (the impedance in a case where viewing the entire device grouping 61 as one load) based on the read-out impedance and supplies the composite value to the communication unit 84. Here, in a case where only one electrical appliance is connected to the communication device 41n, the impedance calculation unit 82 supplies the impedance which is read out from the table stored in the table storage unit 83 as is as the composite value and supplies the impedance to the communication unit 84.

Here, in the communication unit 84, the AC power source phase information and the voltage value information (for example, if it is single phase 100 V, the phase information that is single phase and the voltage value information that is 100 V) may be supplied together. Here, the AC power source phase information and the voltage value information are, for example, detected by the power detection unit 81 which is directly connected to the AC power source and is supplied to the communication unit 84.

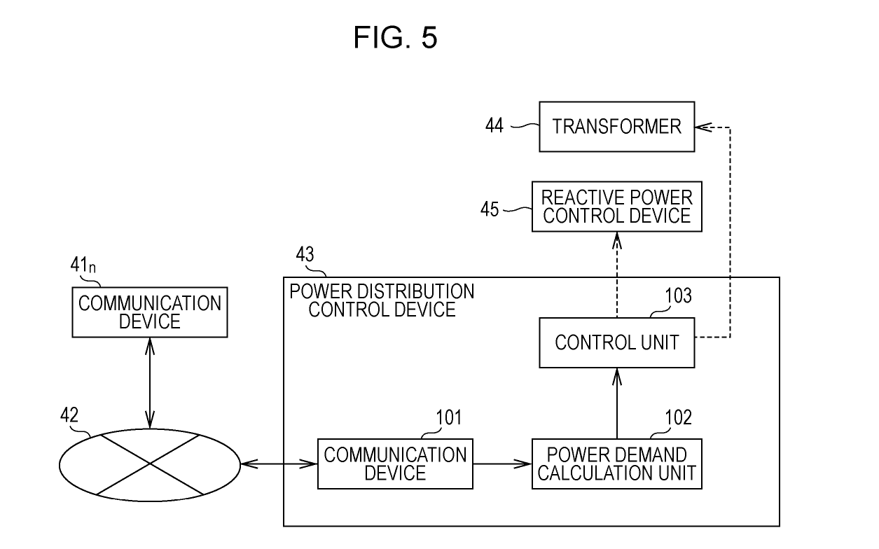

In this case, the communication unit 84 transmits the AC power source phase information and the voltage value information with the composite value to the power distribution control device 43 of FIG. 5 via the network 42. Then, in the power distribution control device 43 of FIG. 5, the power distribution is controlled based on the AC power source phase information and the voltage value information from the communication unit 84 as well as on the composite value from the communication unit 84. Here, in this case, there is a description where the communication unit 84 transmits only the composite value to the power distribution control device 43 of FIG. 5.

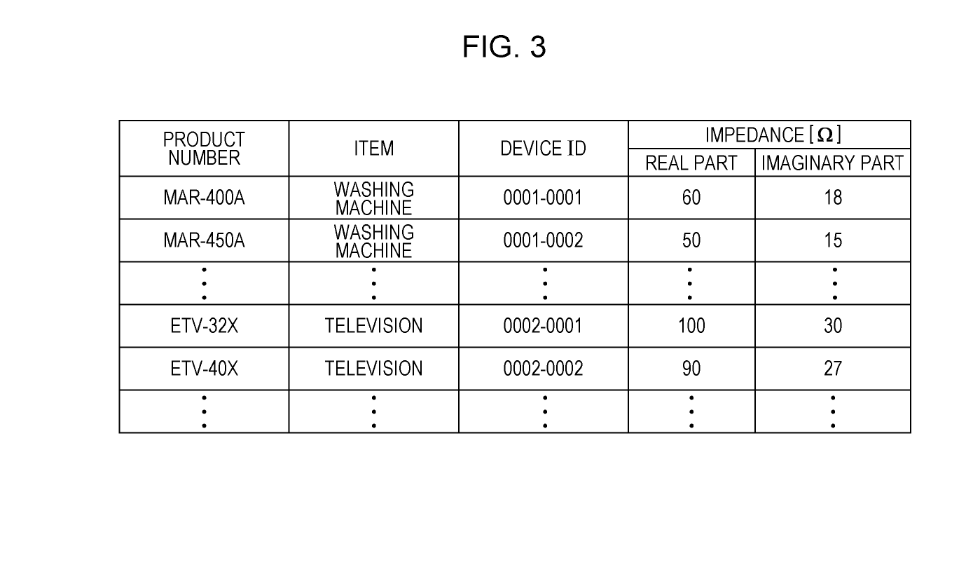

The table storage unit 83 stores (holds) in advance a table where each of the product number, item, device ID and impedance of the electrical appliances correspond for each of the different electrical appliances as shown in FIG. 3. Here, the impedance is expressed using a complex number format.

In addition, in the table held in the table storage unit 83, one impedance corresponds to each of the electrical devices as shown in FIG. 3. Accordingly, in the table held in the table storage unit 83, for example, electrical devices where the impedance is the same are registered irrespective of their operation.

Here, in the table held in the table storage unit 83, electrical appliances where the impedance changes according to the operation may be registered. In this case, for example, the average impedance which changes in accordance with the operation of the electrical appliance is registered as the impedance.

Here, other than the table storage unit 83 being provided for each communication device 41n, a server may be prepared which is a server which is connected to the network 42 and where a table such as that shown in FIG. 3 is held in advance. In this case, the impedance calculation unit 82 reads out the table from the server which is connected to the network 42 and acquires the impedance for each electrical appliance which configures the device grouping 61.

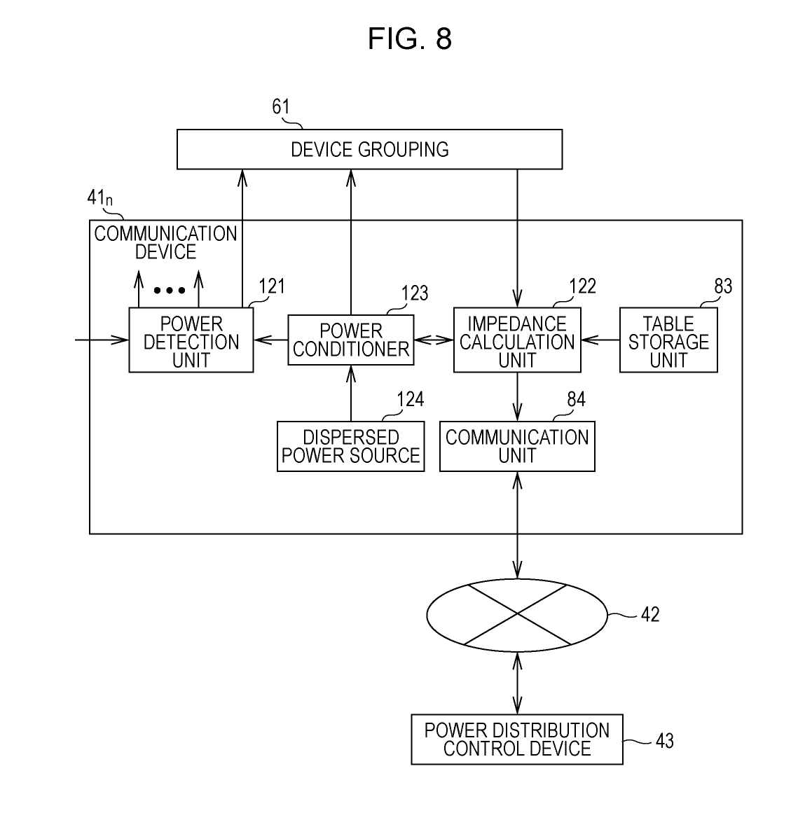

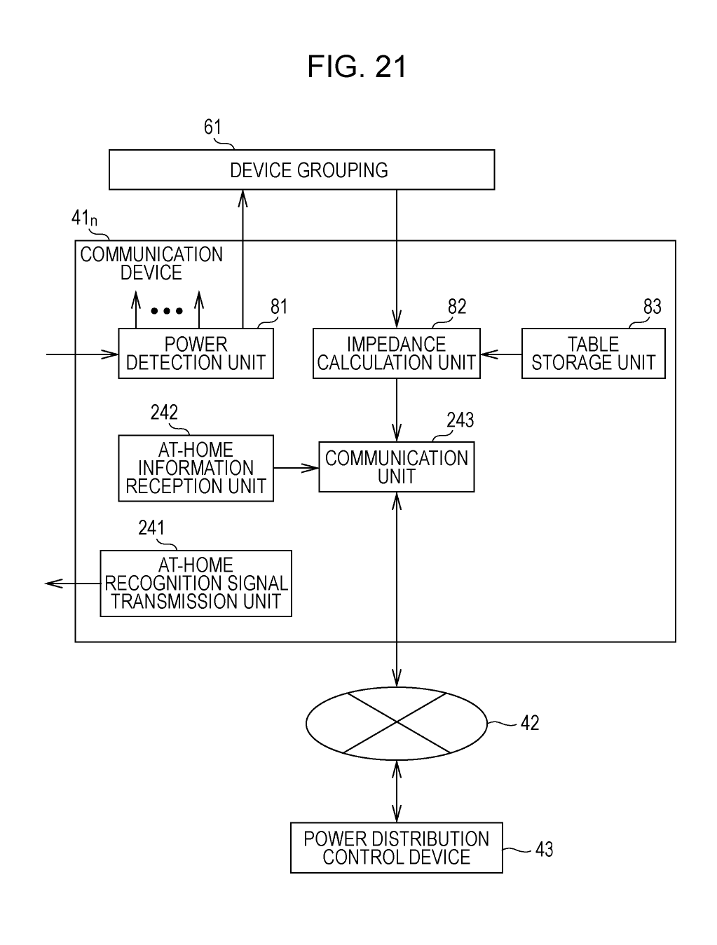

In a case where the server which holds the table such as that shown in FIG. 3 in advance is prepared, it is not necessary for the table such as that shown in FIG. 3 to be replicated and held for each communication device 41n and it is possible to omit the table storage unit 83. In addition, a plurality of the servers may be provided when necessary. This is the same for the other communication devices 41n which will be described later (for example, the communication devices 41n which are described with reference to FIGS. 8 and 21).

The communication unit 84 supplies the composite value from the impedance calculation unit 82 to the power distribution control device 43 of FIG. 5 via the network 42.

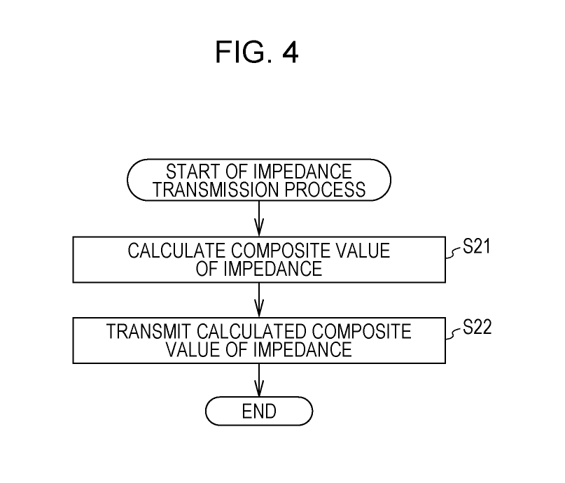

Next, an impedance transmission process which is performed by the communication device 41n of FIG. 2 will be described with reference to the flowchart of FIG. 4.

In step S21, the impedance calculation unit 82 acquires the device ID for each electrical appliance which configures the device grouping 61 which is connected to the communication device 41n. In addition, the impedance calculation unit 82 reads out the impedance which corresponds to each device ID of each electrical appliance which configures the device grouping 61 from the table which is stored in the table storage unit 83. Then, the impedance calculation unit 82 calculates the composite value which expresses the impedance of the entire device grouping 61 based on the read-out impedance and supplies the composite value to the communication unit 84.

In step S22, the communication unit 84 supplies the composite value from the impedance calculation unit 82 to the power distribution control unit 43 via the network 42. This completes the impedance transmission process.

As described above, according to the impedance transmission process, for example, it is possible for the communication device 41n to transmit the composite value of the impedance, which is necessary to calculate the power consumption which is consumed in the household 21n, to the power distribution control device 43.

[First Configuration Example of Power Distribution Control Device 43]

Next, FIG. 5 illustrates a configuration example of the power distribution control device 43 which receives the composite value from the communication device 41n of FIG. 2.

The power distribution control device 43 is configured from a communication unit 101, a power demand calculation unit 102, and a control unit 103.

The communication unit 101 receives the composite value for each communication device 41n which is supplied from the communication device 41n via the network 42 and supplies the composite value to the power demand calculation unit 102.

The power demand calculation unit 102 calculates the power consumption for each household 21n which is included in the region 21 based on the composite value of each communication device 41n from the communication unit 101. Then, the power demand calculation unit 102 supplies the total of the calculated power consumption for each household 21n as the power demand of the region 21 to the control unit 103. Here, the calculation of the power demand is performed in consideration of the affects of the reactance component of the transmission lines, the transformer 44, and the like. In addition, in a case where the AC power source phase information and the voltage value information of the household 21n are also transmitted from the communication device 41n of FIG. 2, the power demand is calculation in consideration of the affect due to the AC power source based on the AC power source phase information and the voltage value information of the household 21n. Furthermore, the power demand is calculated using a complex number format.

The control unit 103 controls the transformer 44 and the reactive power control device 45 based on the power demand from the power demand calculation unit 102. That is, for example, the control unit 103 holds a control table, where the transformation ratio which is to be set in accordance with power demand, the reactance amount with regard to the reactive power, and the like correspond for each level of power demand, in a memory or the like (not shown). Then, the control unit 103 determines the transformation ratio, the reactance amount, and the like which are to be set using the held control table based on the power demand from the power demand calculation unit 102 and controls the transformation ratio of the transformer 44 and the reactance amount of the reactive power control device 45 so as to be the determined transformation ratio and reactance amount. Here, the electrical power company and the like calculate the appropriate transformation ratio, reactance amount, and the like in accordance with the power demand and the control table is created in advance based on the calculation results.

Here, for example, in a case where the transformation ratio of the transformer 44 is the transformation ratio which is to be set, the control unit 103 only controls the reactive power control device 45 and it is possible to set the reactance amount of the reactive power control device 45 to the reactance amount which is to be set.

In addition, for example, in a case where the reactance amount of the reactive power control device 45 is the reactance amount which is to be set, the control unit 103 only controls the transformer 44 and it is possible to set the transformation ratio of the transformer 44 to the transformation ratio which is to be set.

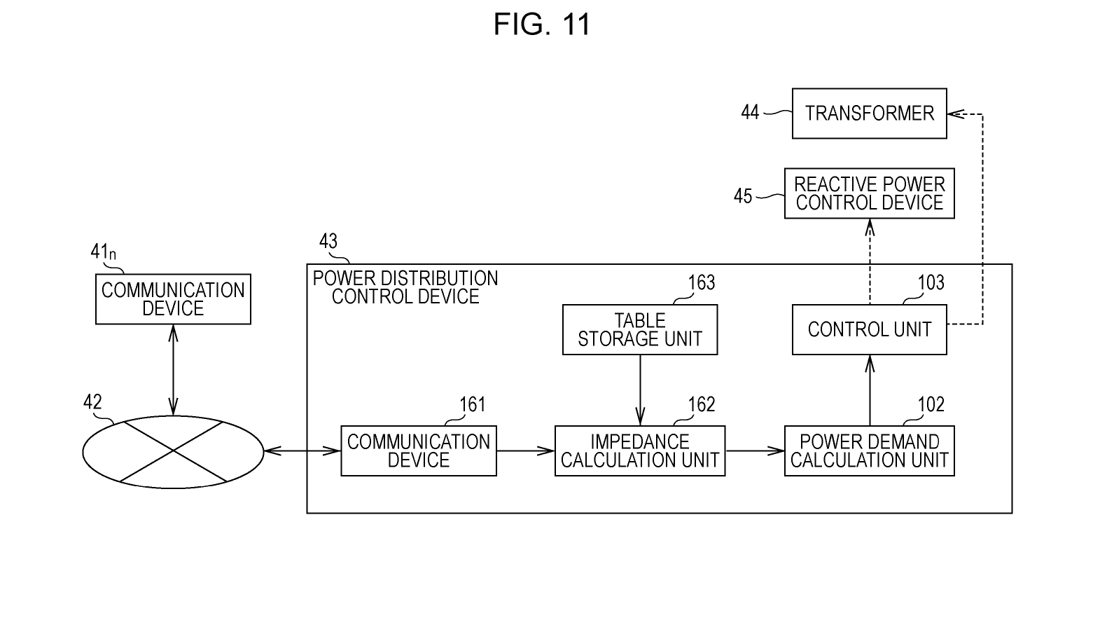

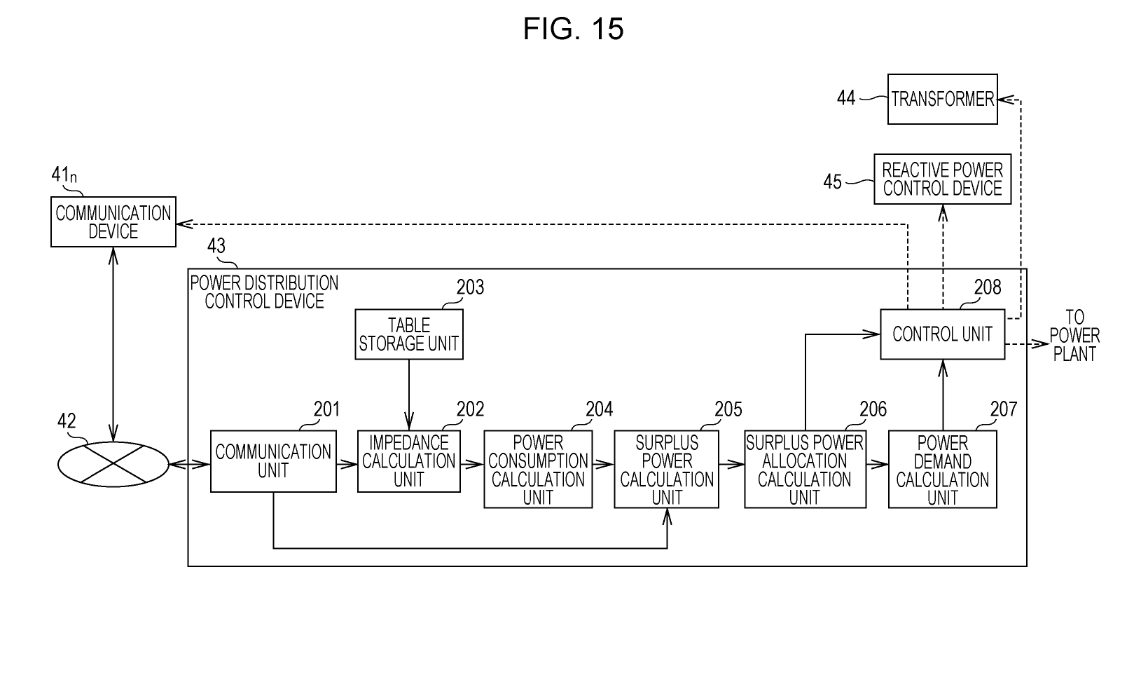

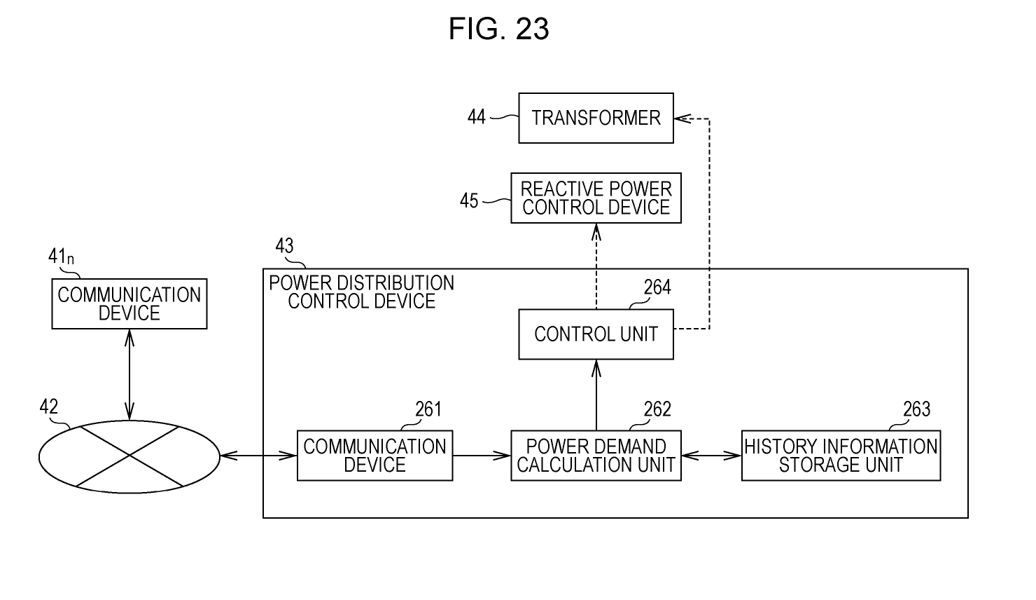

That is, it is possible for the control unit 103 to control at least one of the transformer 44 or the reactive power control device 45 based on the power demand from the power demand calculation unit 102. Furthermore, it is needless to say that the control unit 103 sequentially controls the transformer 44 or the reactive power control device 45 by changing the timing. From this, it is possible to say that same about the control unit 103 of FIG. 11, the control unit 208 of FIG. 15, and the control unit 264 of FIG. 23 which will be described later.

Furthermore, in FIG. 5, instead of the one power distribution control device 43, for example, a first power distribution control device 43 and a second power distribution control device 43 may be provided. Then, the control unit 103 of the first power distribution control device 43 may perform control of the transformer 44 and the control unit 103 of the power distribution control device 43 may perform control of the reactive power control device 45. From this, it is possible to say that same about the power distribution control devices 43 of FIGS. 11, 15, and 23 which will be described later.

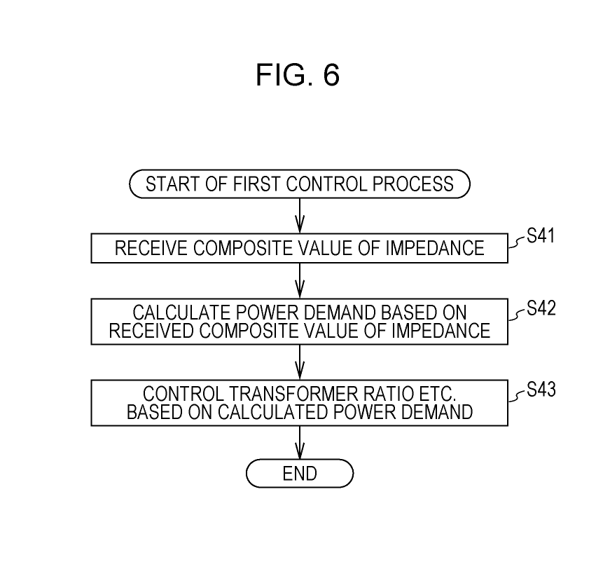

Next, a process (referred to below as a first control process) where the power distribution control device of FIG. 5 controls the transformer 44 and the reactive power control device 45 will be described with reference to the flowchart of FIG. 6.

In step S41, the communication unit 101 receives the composite value for each communication device 41n which is supplied from the communication devices 41n via the network 42 and supplies the composite value to the power demand calculation unit 102.

In step S42, the power demand calculation unit 102 calculates the power consumption for each household 21n included in the region 21 based on the composite value for each communication device 41n from the communication unit 101. Then, the power demand calculation unit 102 supplies a total of the calculated power consumption for each household 21n as the power consumption of the region 21 to the control unit 103.

In step S43, the control unit 103 controls the transformer 44 and the reactive power control device 45 based on the power demand from the power demand calculation unit 102. This completes the first control process.

As described above, according to the first control process, the power consumption of each household 21n is calculated based on the composite value of each communication device 41n which is supplied via the network 42 and the total of the calculated power consumption of each household 21n is set as the power demand of the region 21.

As a result, it is possible for the power distribution control device 43 of FIG. 5 to accurately calculate the power demand of the region 21 compared to a case where the power demand is predicted (calculated) based on, for example, the past history of power demand in the region 21. Accordingly, it is possible for the power distribution control device 43 of FIG. 5 to perform power distribution to the households 21n at a voltage value in a range of 95 V to 107 V by controlling the transformer 44 and the reactive power control device 45 based on the calculated power demand.

In addition, according to the first control process, it is possible for the power distribution control device 43 to improve the power factor (for example, improving so that power factor cos θ is close to one) based on the effective power and the reactive power which configure the calculated power demand. Here, effective power is power which is actually consumed in the load of electrical appliances and the like.

<2. Modified Example of First Embodiment>

Here, in FIG. 2, the impedance calculation unit 82 calculates the impedance of the entire device grouping 61 which is connected to the communication device 41n as the composite value irrespective of whether or not each of the electrical appliances which configures the device grouping 61 is in a powered state.

However, it is the electrical appliances where the power source has been turned on and which are in a powered state that actually consume electrical power. Accordingly, the impedance calculation unit 82 may calculate the composite vale with only the electrical appliances in the device grouping 61 which are in a power state as the targets.

That is, for example, each of the electrical appliances in the device grouping 61 supplies their device ID to the impedance calculation unit 82 of the communication device 41n when in a powered state. Then, it is possible for the impedance calculation unit 82 to calculate the composite value which targets only the electrical appliances in a powered state using the device ID from the electrical appliances in the device grouping 61 and the table which is stored in the table storage unit 83.

In this case, in the communication device 41n of FIG. 2, the composite value which targets only the electrical appliances which actually consume electrical power is calculated and transmitted. As such, compared to a case where the composite value where the electrical appliances connected to the communication device 41n are the targets is calculated and transmitted, it is possible for the power consumption of each household 21n to be calculated more accurately in the power distribution control device 43 of FIG. 5. As a result, it is possible to more accurately calculate the power demand of the region 21 which is the total of the power consumption for each household 21n. As a result, it is possible to perform more appropriate control in the power distribution control device 43 of FIG. 5 in accordance with the power demand of the region 21.

In addition, for example, other than the power state, the impedance calculation unit 82 may calculate the composite value in consideration of which of the operation modes each of the electrical appliances which configure the device grouping 61 are operating in when in a power state. This depends on the power consumption of the electrical appliances being different according to the operation mode. Here, as the operation modes, for example, in a case of where the electrical appliance is an AV device, there is a low power consumption mode, a high power consumption mode, and the like, and in a case of where the electrical appliance is a washing machine, there are the operation modes of washing, rinsing, spinning, and the like.

That is, for example, the electrical appliances which are in a power state out of each electrical appliance in the device grouping 61 supplies a mode ID which expresses the current operation mode along with the device ID to the impedance calculation unit 82 of the communication device 41n.

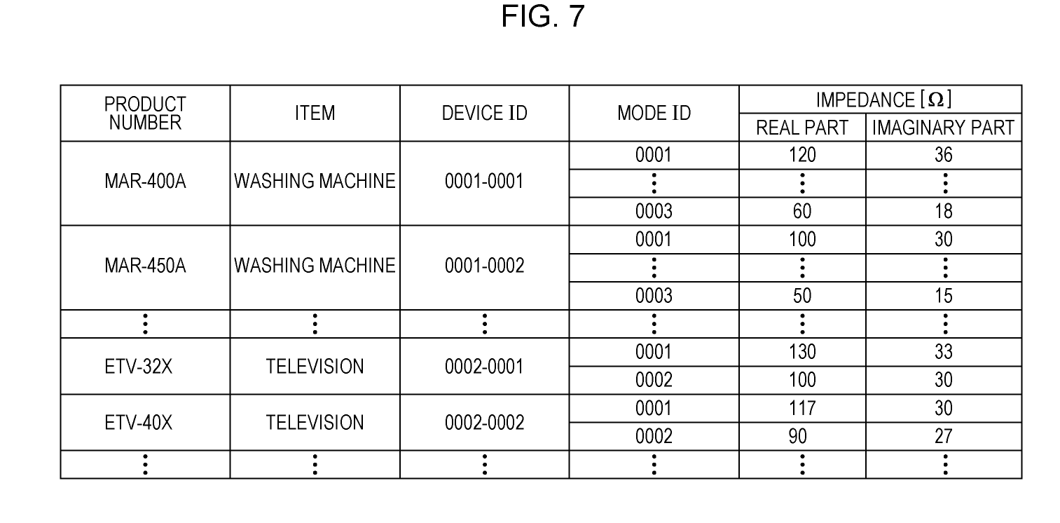

It is possible for the impedance calculation unit 82 to calculate the composite value where only the electrical appliances in a power state are the targets using the device ID and the mode ID from the electrical appliances in the device grouping 61 and the table stored in the table storage unit 83. Here, in this case, a table where each of the product number, item, device ID, mode ID, and impedance of the electrical appliances correspond for each of the different electrical appliances is stored in the table storage unit 83 as shown in FIG. 7.

In addition, in the table shown in FIG. 7, a plurality of mode IDs and the impedance which corresponds to each of the plurality of mode IDs correspond with regard to the electrical appliances which operate using the plurality of operation modes as shown in the diagram.

However, in the table shown in FIG. 7, although not shown, the correspondence of one operation mode ID and the impedance which corresponds to the one operation mode ID may be included with regard to the electrical appliances which operate using the one operation mode.

Here, the impedance calculation unit 82 may obtain cyclic characteristics from the history of the device IDs and the mode IDs supplied from the electrical appliances which have operation modes with a cyclic nature and the cyclic characteristics may be reflected in the table storage unit 83. Specifically, for example, in a case where the electrical appliance is a washing machine, if necessary time for washing which is a first operation mode is 10 minutes, necessary time for rinsing which is a second operation mode is 5 minutes, and necessary time for spinning which is a third operation mode is 3 minutes, there is a situation where the impedance calculation unit 82 reflects the necessary times in the table which is stored in the table storage unit 83.

In this case, for example, even if the washing machine does not supply a mode ID which expresses the operation mode after transition in accordance with the transition of the operation mode to the impedance calculation unit 82, the impedance calculation unit 82 is able to distinguish the impedance of the washing machine in accordance with the cyclic nature of the washing machine based on the table stored in the table storage unit 83.

In a case where the operation mode is taken into consideration, in the communication device 41n of FIG. 2, the composite value is calculated and transmitted with the operation mode of the electrical appliances which actually consume electrical power taken into consideration. As such, it is possible to more accurately calculate the power demand of the region 21 in the power distribution control unit 43 shown in FIG. 5 compared to a case where the composite value is calculated and transmitted without the operation mode being taken into consideration. As a result, it is possible to perform more appropriate control in the power distribution control device 43 of FIG. 5 in accordance with the power demand of the region 21.

In addition, in the first embodiment, the communication device 41n of FIG. 2 has been described, but other than this, for example, it is possible to adopt the communication device 41n which uses electrical power obtained from solar panels and the like other than electrical power from a power plant in an auxiliary manner. That is, in the first embodiment, it is possible to adopt only the communication device 41n of FIG. 2, only the communication device 41n of FIG. 8 which will be described later, or both of the communication devices 41n as the communication devices 411 to 41n.

[Other Configuration Examples of Communication Device 41n in First Embodiment]

Next, FIG. 8 illustrates a configuration example of the communication device 41n with a dispersed power source such as solar panels.

Here, the communication device 41n of FIG. 8 is configured in the same manner as the communication device 41n of FIG. 2 other than electrical power which is obtained from a disbursed power source is sold to an electrical power company and the electrical power which is obtained from the dispersed power source is used as electrical power for operating the device grouping 61.

In addition, in regard to portions of the communication device 41n of FIG. 8 which are configured in the same manner as the communication device 41n of FIG. 2, the description is appropriately omitted since the same reference numerals are attached.

That is, the communication device 41n of FIG. 8 is configured in the same manner as the communication device 41n of FIG. 2 other than a power detection unit 121 and a impedance calculation unit 122 are provided instead of the power detection unit 81 and the impedance calculation unit 82 and a power conditioner 123 and a dispersed power source 124 are newly provided.

The power detection unit 121 is connected to the AC power source in the household 21n via the electrical power wiring and supplies electrical power from the AC power source to the table storage unit 83, the communication unit 84, the impedance calculation unit 122, and the power conditioner 123 in the communication device 41n and to the device grouping 61.

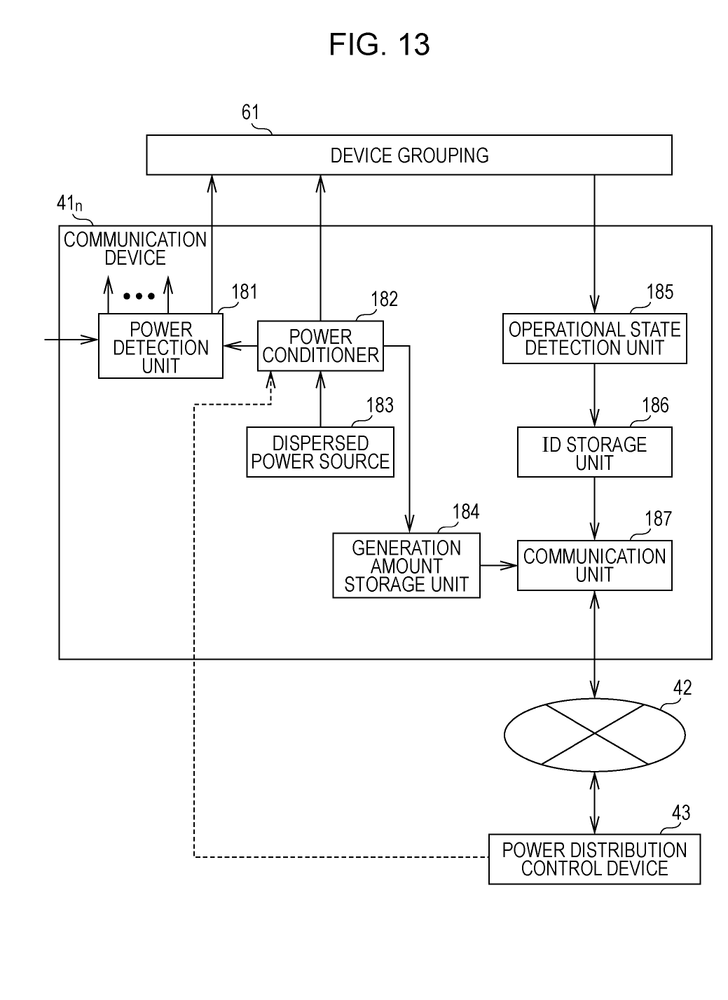

In addition, the power detection unit 121 supplies electrical power from the power conditioner 123 which is supplied for selling is supplied to the electrical power wiring via the AC power source in the household 21n. The power electrical is not supplied to the power plant via the electrical power wiring and is directly supplied to another household 21m (n≠m). Here, the power conditioner 123 is controlled by the power distribution control device 43 in a case such as where the electrical power for selling is supplied to the power detection unit 121. The control of the power conditioner 123 using the power distribution control device 43 is omitted here since it will be described in detail layer with reference to FIG. 13 and the like.

Furthermore, the amount of electrical power and the like of the electrical power from the power conditioner 123 is detected by the power detection unit 121 and displayed on a display device (not shown) or the like which is provided outside the household 21n. Here, along with the amount of electrical power and the like of the electrical power which is sold, the amount of electrical power and the like when the electrical power from the power plant is consumed in the household 21n is displayed in the display device. At the electrical power company, the amount of electrical power and the like which is displayed on the display device is confirmed in person, for example, once a month, and a request for electrical power fees or transfer of fees for electrical power which was sold are performed from the electrical power company with regard to the residents living in the household 21n based on the confirmed items.

The impedance calculation unit 122 calculates the composite value in the same manner as the impedance calculation unit 82 and transmits the composite value to the power conditioner 123. In addition, the impedance calculation unit 122 corrects the composite value which has been calculated in accordance with control from the power conditioner 123 and supplies the composite value to the communication unit 84.

The power conditioner 123 calculates electrical power (power consumption) which is necessary in the device grouping 61 based on the composite value from the impedance calculation unit 122. Then, the power conditioner 123 determines whether or not the electrical power from the dispersed power source 124 is larger than the power consumption of the device grouping 61 and corrects the composite value which has been calculated by the impedance calculation unit 122 in accordance with the detection result.

That is, for example, in a case where it is determined that the electrical power from the dispersed power source 124 is larger than the power consumption of the device grouping 61, that is, in a case where it is determined that the electrical power necessary for the device grouping 61 is completely provided from the electrical power from the dispersed power source 124, the power conditioner 123 corrects the composite value which has been calculated to infinity (a sufficiently large number) by controlling the impedance calculation unit 122 and supplies the composite value to the communication unit 84.

Due to this, in the power distribution control device 43 of FIG. 5, the power consumption of the device grouping 61 in the household 21n is treated as being zero and the power demand of the region 21 is calculated.

In addition, in a case where the electrical power from the dispersed power source 124 is determined to be smaller than the power consumption of the device grouping 61, that is, in a case where it is determined that it is necessary that a portion of the power consumption of the device grouping 61 is provided by the electrical power from the transmission lines, the power conditioner 123 corrects the composite value which has been calculated to a value according to a ratio of the power consumption of the device grouping 61 and the electrical power obtained using the dispersed power source 124 by controlling the impedance calculation unit 122 and supplies the composite value to the communication unit 84.

Due to this, in the power distribution control device 43 of FIG. 5, the remaining power consumption which is obtained by subtracting the electrical power obtained using the dispersed power source 124 from the power consumption of the device grouping 61 in the household 21n is treated as the power consumption of the device grouping 61 in the household 21n and the power demand of the region 21 is calculated.

Furthermore, the power conditioner 123 converts the electrical power from the dispersed power source 124 from a direct current to an alternating current and supplies the electrical power after conversion to the device grouping 61 or the power detection unit 121.

The dispersed power source 124 is, for example, a solar panel, a storage battery, or the like and the electrical power which is obtained using power generation is supplied to the power conditioner 123.

That is, the dispersed power source 124 may be any device which generates electrical power by itself as a power source.

Specifically, for example, in a case of a solar panel, the dispersed power source 124 supplies electrical power which is generated using the power generation of the solar panel to the power conditioner 123. In addition, for example, in a case of a storage battery, the dispersed power source 124 supplies electrical power which is generated using the power generation (discharge of power) of the storage battery to the power conditioner 123.

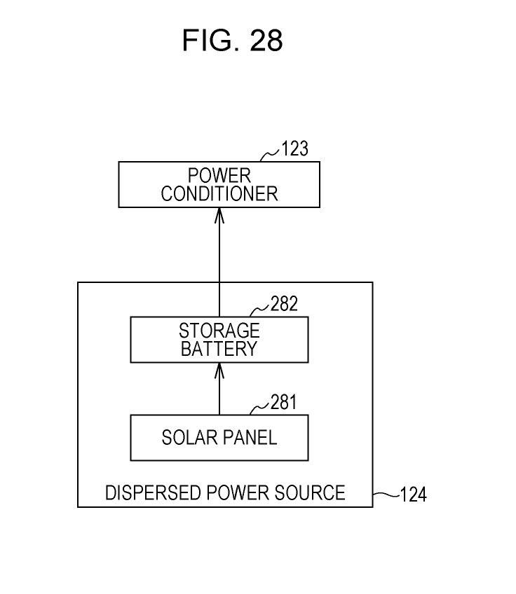

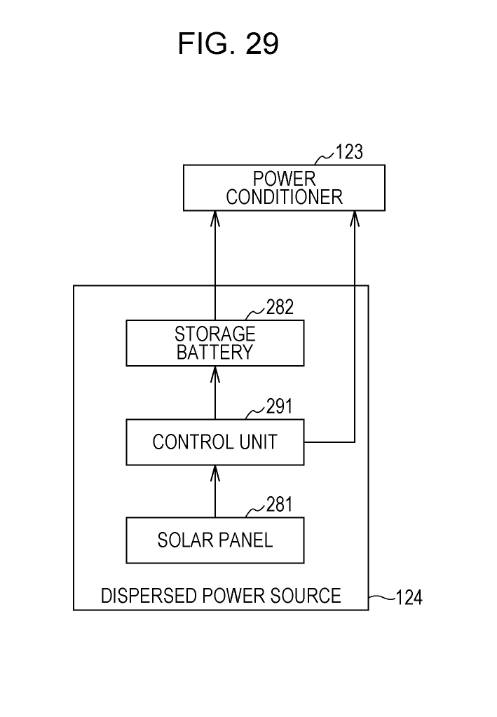

Below, the dispersed power source 124 will be described as one of a solar panel or a storage panel. Here, a case where the dispersed power source 124 is a solar panel and a storage battery will be described in detail later with reference to FIGS. 28 and 29.

In the communication device 41n of FIG. 8, the composite value of the device grouping 61 is corrected and transmitted in consideration of the electrical power obtained from the dispersed power source 124. As a result, in the power distribution control device 43 of FIG. 5, it is possible to accurately calculate the power consumption (the power consumption which is necessary to be provided using the electrical power from the transmission lines) of the device grouping 61 in the household 21n where the power consumption which is provided by the electrical power obtained from the dispersed power source 124 has been removed. As such, in the power distribution control device 43 of FIG. 5, it is possible to comparatively accurately calculate the power demand of the region 21 (electrical power which is to be supplied to the transmission lines).

In the first embodiment, the communication device 41n of FIG. 2 calculates the composite value and transmits the composite value to the power distribution control device 43 of FIG. 5, but the calculation of the composite value may be performed by the power distribution control device 43. In this case, the communication device 41n transmits the obtained device IDs to the power distribution control device 43 and the composite value is calculated in the power distribution control device 43 using the table of FIG. 3 based on the device IDs from the communication device 41n. Then, the power distribution control unit 43 calculates the power demand of the region 21 based on the calculated composite value. Here, the communication device 41n which transmits the device ID to the power distribution control unit 43 may be configured to have or not have a dispersed power source.

Other than this, for example, the communication device 41n may transmit the obtained device IDs and mode IDs to the power distribution control device 43 and the composite value may be calculated in the power distribution control device 43 using the table of FIG. 7 based on the device IDs and the mode IDs from the communication device 41n.

<3. Second Embodiment>

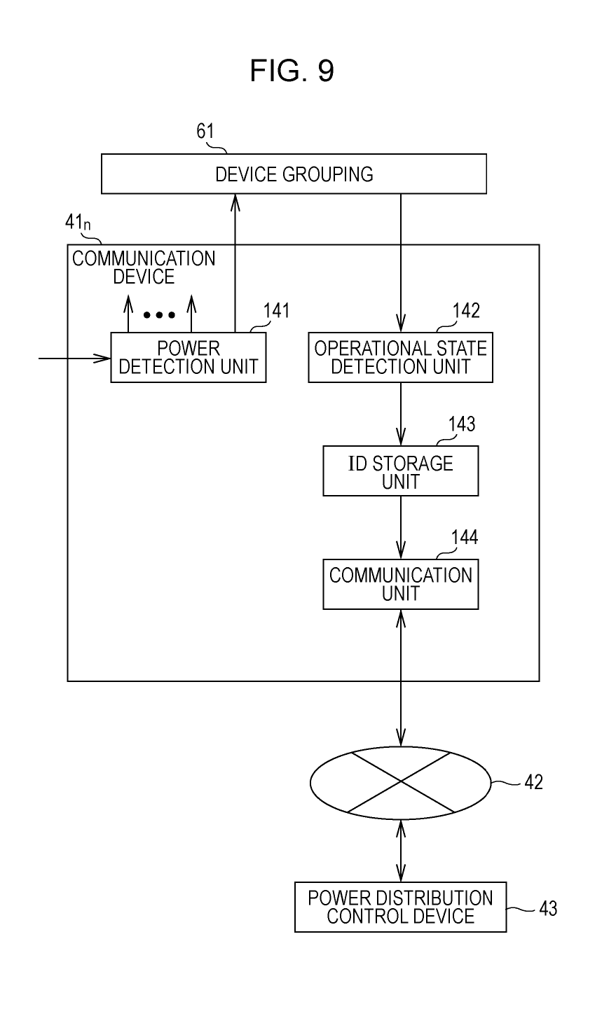

Next, the power distribution control system 1 will be described with reference to FIGS. 9 to 12 in a case where the device IDs and the mode IDs which are used in the calculation of the composite value are transmitted in the communication device 41n and the composite value is calculated in the power distribution control device 43 using the device IDs and the mode IDs from the communication device 41n.

[Second Configuration Example of Communication Device 41n]

FIG. 9 illustrates a configuration example of the communication device 41n which obtains and transmits the device IDs and the mode IDs used in the calculation of the composite value.

The communication device 41n of FIG. 9 is configured from a power detection unit 141, an operational state detection unit 142, an ID storage unit 143, and a communication unit 144.

The power detection unit 141 is connected to the AC power source in the household 21n via the electrical power wiring and supplies electrical power from the AC power source to the operational state detection unit 142, the ID storage unit 143, and the communication unit 144 and to the device grouping 61. In addition, the power detection unit 141 detects the amount of electrical power of the power consumption which supplied to the device grouping 61 from the AC power source and is consumed and displays the amount of electrical power on a display device or the like (not shown) which is provided outside of the household 21n in the same manner as the power detection unit 81.

The operational state detection unit 142 detects the device ID and the mode ID of each of the electrical appliances which configure the device grouping 61 and the device IDs and the mode IDs are stored by being supplied to the ID storage unit 143.

That is, for example, in the operational state detection unit 142, the device IDs and the mode IDs of the electrical appliances are supplied from the electrical appliances which are in a powered state out of each of the electrical appliances which configure the device grouping 61. The operational state detection unit 142 supplies the device IDs and the mode IDs from the electrical appliances which configure the device grouping 61 to the ID storage unit 143 and the device IDs and the mode IDs are stored.

The ID storage unit 143 stores the device IDs and the mode IDs from the operational state detection unit 142.

The communication device 144 reads out the device IDs and the mode IDs which are stored in the ID storage unit 143 from the ID storage unit 143 and supplies the device IDs and the mode IDs to the power distribution control device 43 via the network 42. Here, the communication device 144 may supply the AC power source phase information and the voltage value information (for example, if it is single phase 100 V, the phase information that is single phase and the voltage value information that is 100 V) to the power distribution control device 43 of FIG. 11. Here, the AC power source phase information and the voltage value information are detected by, for example, the power detection unit 141 which is directly connected to the AC power source and are supplied to the communication unit 144.

In this case, the communication device 144 transmits the AC power source phase information and the voltage value information with the device IDs and the mode IDs to the power distribution control device 43 of FIG. 11 via the network 42. Then, in the power distribution control device 43 of FIG. 11, power distribution is controlled based on the AC power source phase information and the voltage value information from the communication unit 144 along with the device IDs and the mode IDs from the communication unit 144. Here, in this case, the communication device 144 is described as only transmitting the device IDs and the mode IDs to the power distribution control device 43 of FIG. 11.

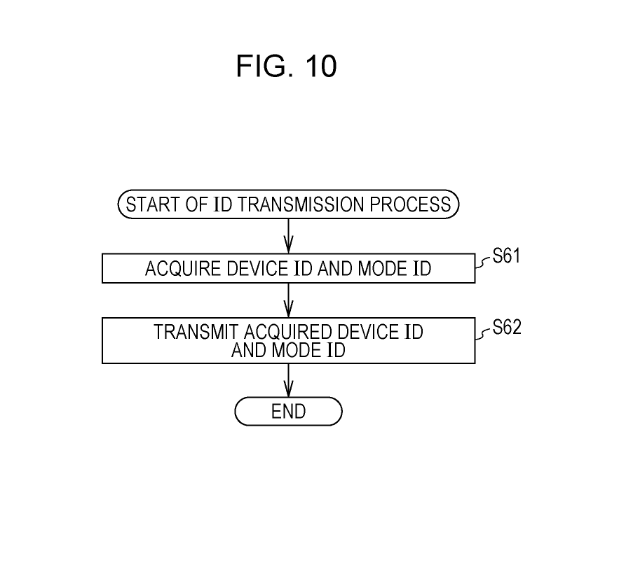

Next, an ID transmission process which is performed by the communication device 41n of FIG. 9 will be described with reference to the flowchart of FIG. 10.

In step S61, the operational state detection unit 142 detects the device IDs and the mode IDs of each of the electrical appliances which configure the device grouping 61 and the device IDs and the mode IDs are stored by being supplied to the ID storage unit 143.

In step S62, the communication unit 144 reads out the device IDs and the mode IDs which are stored in the ID storage unit 143 from the ID storage unit 143 and supplies the device IDs and the mode IDs to the power distribution control device 43 via the network 42. This completes the ID transmission process.

As described above, according to the ID transmission process, since the device IDs and the mode IDs of the device grouping 61 are transmitted, it is possible to omit the process of calculating the composite value using the device IDs and the mode IDs.

[Second Configuration Example of Power Distribution Control Device 43]

Next, FIG. 11 illustrates a configuration example of the power distribution control device 43 which calculates the composite value based on the device IDs and the mode IDs from the communication device 41n of FIG. 9 and calculates the power demand based on the composite value.

Here, the power distribution control device 43 of FIG. 11 is configured in the same manner as the power distribution control device 43 of FIG. 5 other than a communication unit 161, an impedance calculation unit 162, and a table storage unit 163 are provided instead of the communication unit 101 of FIG. 5. In the portions which are configured in the same manner, the description is appropriately omitted since the same reference numerals are attached.

The communication unit 161 receives the device IDs and the mode IDs which are supplied from the communication device 41n of FIG. 9 via the network 42 and supplies the device IDs and the mode IDs to the impedance calculation unit 162.

The impedance calculation unit 162 reads out the impedance which corresponds to the device ID and the mode ID from the communication unit 161 from the table which is stored in advance in the table storage unit 163. Then, the impedance calculation unit 162 calculates the composite value based on the read-out impedance and supplies the composite value to the power demand calculation unit 102.

The table storage unit 163 stores in advance a table where the impedance corresponds with at least the device IDs and the mode IDs as shown in FIG. 7. Here, the table storage unit 163 may be configured so as to be connected to the network 42 as a server without being provided in the power distribution control device 43 of FIG. 11.

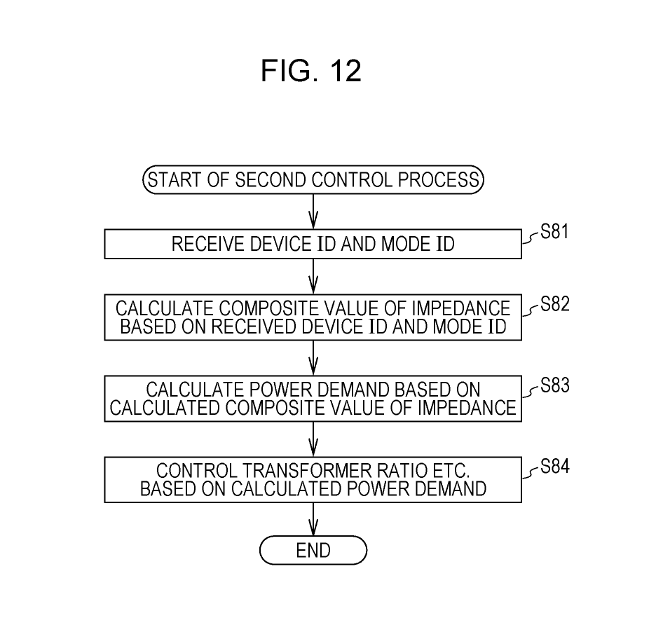

Next, a process (referred to below as a second control process) where the power distribution control device 43 of FIG. 11 calculates the power demand based on the device IDs and the mode IDs from the communication device 41n of FIG. 9 and controls the transformer 44 and the reactive power control device 45 based on the calculated power demand will be described with reference to the flowchart of FIG. 12.

In step S81, the communication unit 161 receives the device IDs and the mode IDs which are supplied from the communication device 41n of FIG. 9 via the network 42 and supplies the device IDs and the mode IDs to the impedance calculation unit 162.

In step S82, the impedance calculation unit 162 reads out the impedance which corresponds to the device ID and the mode ID from the communication unit 161 from the table which is stored in advance in the table storage unit 163. Then, the impedance calculation unit 162 calculates the composite value based on the read-out impedance and supplies the composite value to the power demand calculation unit 102.

In steps S83 and S84, the processes are performed respectively in the same manner as steps S42 and S43 of FIG. 6. This completes the second control process.

As described above, according to the second control process, the power distribution control device 43 of FIG. 11 calculates the composite value of the device grouping 61 in the household 21n based on the device IDs and the mode IDs for each communication device 41n which is supplied via the network 42 without calculating the composite value in the communication device 41n.

As a result, according to the second control process, since it is not necessary to provide a function for calculating in the composite value in the communication device 41n, it is possible to simplify the functions of the communication device 41n. Due to this, it is possible to realize the power distribution control system 1 where so-called grid computing is realized, that is, the power distribution control system 1 where processing using the communication device 41n is reduced as much as possible and processing is performed in the power distribution control device 43 which is connected to the network 42.

In the second embodiment, the communication device 41n of FIG. 9 has been described, but other than this, for example, it is possible to adopt the communication device 41n which uses electrical power obtained from solar panels and the like other than electrical power from a power plant in an auxiliary manner. That is, in the second embodiment, it is possible to adopt only the communication device 41n of FIG. 9, only the communication device 41n of FIG. 13 which will be described later, or both of the communication devices 41n as the communication devices 411 to 41N.

Here, in a case where the communication device 41n of FIG. 13 is adopted as the communication devices 411 to 41n, the configuration of the power distribution control device 43 is as shown in FIG. 15 which will be described later.

Next, the power distribution control system 1 which includes the communication device 41n of FIG. 13 and the power distribution control device 43 of FIG. 15 will be described with reference to FIGS. 13 to 16. That is, a power distribution control system 1 will be described in a case where, in the communication device 41n of FIG. 13, there is a dispersed power source such as a solar panel and the generation amount which is generated from the dispersed power source is transmitted along with the device IDs and the mode IDs which are used in the calculation of the composite value, and in the power distribution control device 43 of FIG. 15, the communication device 41n is controlled according to the device IDs, the mode IDs, and the generation amount from the communication device 41n.

Here, below, a case will be described where the communication device 41n of FIG. 9 is adopted along with the communication device 41n of FIG. 13 as the communication devices 411 to 41N.

<4. Third Embodiment>

[Third Configuration Example of Communication Device 41n]

FIG. 13 illustrates a configuration example of the communication device 41n which transmits the generation amount of the electrical power generated by the dispersed power source along with the device IDs and the mode IDs which are used in the calculation of the composite value.

The communication device 41n of FIG. 13 is configured from a power detection unit 181, a power conditioner 182, a dispersed power source 183, a generation amount storage unit 184, an operational state detection unit 185, an ID storage unit 186, and a communication device 187.

The power detection unit 181 performs processing in the same manner as the power detection unit 121 of FIG. 8.

The power conditioner 182 performs processing in the same manner as the power conditioner 123 of FIG. 8. Other than that, for example, the power conditioner 182 detects the generation amount of the electrical power which is generated by the dispersed power source 183 based on the electrical power from the dispersed power source 183 and the generation amount is stored as the generation amount of the dispersed power source 183 by being supplied to the generation amount storage unit 184.

In addition, the power conditioner 182 supplies the electrical power from the dispersed power source 183 to the power detection unit 181 for selling according to the control from the power distribution control device 43 of FIG. 15.

The dispersed power source 183 performs processing in the same manner as the dispersed power source 124 of FIG. 8. Here, the dispersed power source 183 is configured in the same manner as the dispersed power source 124 of FIG. 8.

The generation amount storage unit 184 stores the generation amount from the power conditioner 182.

The operational state detection unit 185 and the ID storage unit 186 perform processing respectively in the same manner as the operational state detection unit 142 and the ID storage unit 143 of FIG. 9.

The communication device 187 reads out the device IDs and the mode IDs which are stored in the ID storage unit 186 from the ID storage unit 186. In addition, the communication device 187 reads out the generation amount which is stored in the generation amount storage unit 184 from the generation amount storage unit 184. Then, the communication unit 187 supplies the read-out device IDs, mode IDs, and amount of power generation to the power distribution control device 43 shown in FIG. 15 via the network 42.

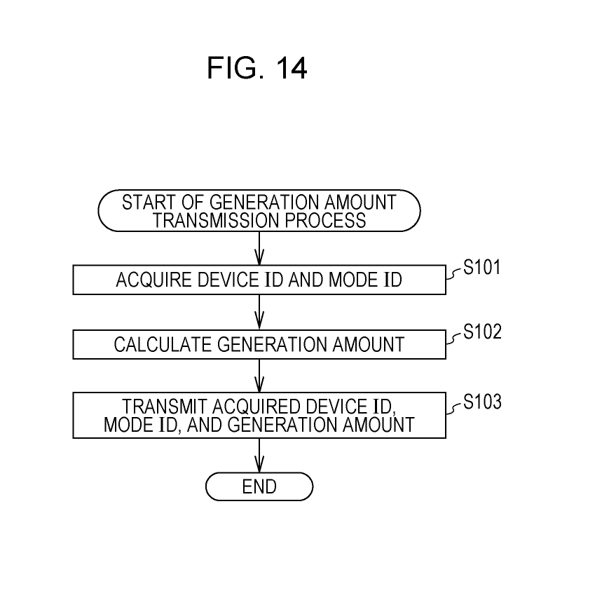

Next, a generation amount transmission process which is performed by the communication device 41n of FIG. 13 will be described with reference to the flowchart of FIG. 14.

In step S101, the operational state detection unit 185 detects the device IDs and the mode IDs of each of the electrical appliances which configure the device grouping 61 and the device IDs and the mode IDs are stored by being supplied to the ID storage unit 186.

In step S102, the operational state detection unit 182 detects the generation amount of the electrical power which is generated by the dispersed power source 183 based on the electrical power from the dispersed power source 183 and the generation amount is stored as the generation amount of the dispersed power source 183 by being supplied to the generation amount storage unit 184.

In step S103, the communication unit 187 reads out the device IDs and the mode IDs which are stored in the ID storage unit 186 from the ID storage unit 186. In addition, the communication unit 187 reads out the generation amount which is stored in the generation amount storage unit 184 from the generation amount storage unit 184. Then, the communication unit 187 supplies the read-out device IDs, mode IDs, and generation amount to the power distribution control device 43 of FIG. 15 via the network 42. This completes the generation amount transmission process.

As described above, according to the generation amount transmission process, since the communication device 41n of FIG. 13 also transmits the generation amount along with the device IDs and the mode IDs, it is possible to calculate the power demand of the region 21 in consideration of the generation amount in the power distribution control device 43 of FIG. 15.

[Third Configuration Example of Power Distribution Control Unit 43]

FIG. 15 illustrates a configuration example of the power distribution control device 43 which controls the transformer 44 and the like based on the device IDs, the mode IDs, and the generation amount from the communication device 41n of FIG. 13.

The power distribution control device 43 of FIG. 15 is configured from a communication device 201, an impedance calculation unit 202, a table storage unit 203, a power consumption calculation unit 204, a surplus power calculation unit 205, a surplus power allocation calculation unit 206, a power demand calculation unit 207, and a control unit 208.

The communication device 201 receives the device IDs and the mode IDs which are supplied from the communication device 41n of FIG. 13 via the network 42 and supplies the device IDs and the mode IDs to the impedance calculation unit 202. In addition, communication device 201 receives the generation amount which is supplied from the communication device 41n of FIG. 13 via the network 42 and supplies the device IDs and the mode IDs to the surplus power calculation unit 205.

Here, in a case where the communication device 41n of FIG. 9 is also adopted along with the communication device 41n of FIG. 13 as the communication devices 411 to 41N of FIG. 1, in the communication unit 201, the device IDs and the mode IDs are transmitted but the generation amount is not transmitted from the communication device 41n of FIG. 9.

Accordingly, in a case where the device IDs and the mode IDs are received from the communication device 41n of FIG. 9, the communication unit 201 supplies the received device IDs and mode IDs to the impedance calculation unit 202 and a generation amount with a value of zero is supplied to the surplus power calculation unit 205 as the generation amount from the communication device 41n of FIG. 9.

The impedance calculation unit 202 performs processing in the same manner as the impedance calculation unit 162 of FIG. 11 based on the device IDs and the mode IDs from the communication unit 201 and supplies the composite value for each communication device 41n which is obtained due to the processing to the power consumption calculation unit 204.

The table storage unit 203 is configured in the same manner as the table storage unit 163 of FIG. 11.

The power consumption calculation unit 204 calculates the power consumption of each household 21n based on the composite value for each communication device 41n from the impedance calculation unit 202 and supplies the power consumption to the surplus power calculation unit 205.

The surplus power calculation unit 205 calculates the surplus power or insufficient power for each household 21n based on the generation amount for each communication device 41n from the communication unit 201 and the consumption power for each household 21n from the power consumption calculation unit 204.

That is, for example, in a case where the difference, which is obtained by subtracting the generation amount of the communication device 41n from the consumption power of the corresponding household 21n, is positive (including zero), the surplus power calculation unit 205 supplies the difference to the surplus power allocation calculation unit 206 as the surplus power of the household 21n.

In addition, for example, in a case where the difference, which is obtained from subtracting the generation amount of the communication device 41n from the consumption power of the corresponding household 21n, is negative, the surplus power calculation unit 205 supplies the absolute value of the difference to the surplus power allocation calculation unit 206 as the insufficient power in the household 21n.

The surplus power allocation calculation unit 206 calculates the allocation amount of the surplus electrical power which is allocated to the household 21n where electrical power is insufficient to the extent of the insufficient power based on the surplus power or insufficient power for each household 21n from the surplus power calculation unit 205. Then, the surplus power allocation calculation unit 206 supplies the calculated allocation amount for each household 21n to the control unit 208.

Due to this, the power conditioner 182 in the communication device 41n of FIG. 13 is controlled in the control unit 208 so that the amount of insufficient power is allocated with regard to the household 21m (n≠m) where electrical power is insufficient to the extent of the insufficient power from the household 21n where electrical power is in surplus to the extent of the surplus power.

In addition, the surplus power allocation calculation unit 206 supplies the surplus power or the insufficient power for each household 21n from the surplus power calculation unit 205 to the power demand calculation unit 207.

The power demand calculation unit 207 calculates the power demand of the region 21, which is obtained by subtracting the total of the surplus power from the total of the insufficient power using the surplus power or the insufficient power for each household 21n from the surplus power allocation calculation unit 206, and supplies the power demand to the control unit 208.

The control unit 208 controls the power plant (not shown) based on the power demand of the region 21 from the power demand calculating unit 207 and controls so as to supply a supply of electrical power with regard to the region 21 from the power plant with electrical power which is equal to or more than the total of the insufficient power.

In addition, the control unit 208 controls the transformer 44 and the reactive power control device 45 based on the power demand of the region 21 from the power demand calculation unit 207 in the same manner as the control unit 103 of FIG. 5.

Furthermore, the control unit 208 controls the power conditioner 182 in the communication device 41n of the household 21n where electrical power is in surplus to the extent of the surplus power based on an allocation amount for each household 21n from the surplus power allocation calculation unit 206 and supplies the surplus power to the household 21m via the power detection unit 181 and the transmission lines. Due to this, the selling of the surplus power in the communication device 41n of the household 21n is able to be performed.

Here, it is possible that the control unit 208 controls the power conditioner 182 in the communication device 41n of the household 21n and supplies the surplus power to the household 21m via the power detection unit 181 and the transmission lines with an improvement in the power factor and the like of the surplus power.

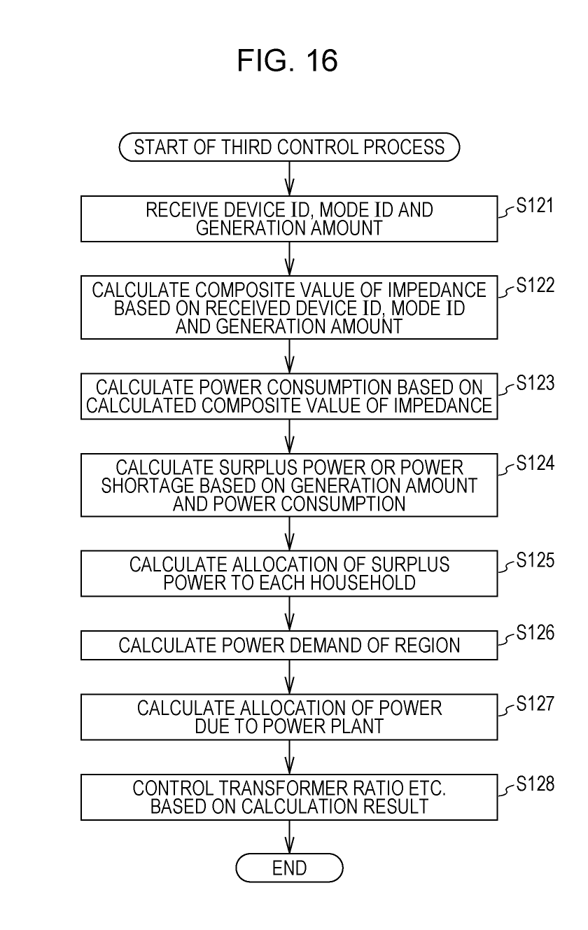

Next, a process (referred to below as a third control process) where the power distribution control device 43 of FIG. 15 controls the transformer 44, the reactive power control device 45, and the power conditioner 182 will be described with reference to the flowchart of FIG. 16.

In step S121, the communication unit 201 receives the device IDs and the mode IDs which are supplied from the communication device 41n of FIG. 13 via the network 42 and supplies the device IDs and the mode IDs to the impedance calculation unit 202. In addition, the communication unit 201 receives the generation amount which is supplied from the communication device 41n of FIG. 13 via the network 42 and supplies the generation amount to the surplus power calculation unit 205.

In step S122, the impedance calculation unit 202 performs processing in the same manner as the impedance calculation unit 162 of FIG. 11 based on the device IDs and the mode IDs from the communication unit 201 and supplies the composite value for each communication device 41n which is obtained by the processing to the power consumption calculation unit 204.

In step S123, the power consumption calculation unit 204 calculates the power consumption for each household 21n based on the composite value for each communication device 41n from the impedance calculation unit 202 and the power consumption is supplied to the surplus power calculation unit 205.

In step S124, the surplus power calculation unit 205 calculates the surplus power or insufficient power of each household 21n based on the generation amount of each communication device 41n from the communication unit 201 and the power consumption of each household 21n from the power consumption calculation unit 204.

In step S125, the surplus power allocation calculation unit 206 calculates the allocation amount of the surplus power which is allocated to the household 21n where electrical power is insufficient to the extent of the insufficient power based on the surplus power or insufficient power of each household 21n from the surplus power calculation unit 205. Then, the surplus power allocation calculation unit 206 supplies the calculated allocation amount for each household 21n to the control unit 208.

Due to this, the power conditioner 182 in the communication device 41n of FIG. 13 is controlled in the control unit 208 so that the amount of insufficient power is allocated with regard to the household 21m (n≠m) where electrical power is insufficient to the extent of the insufficient power from the household 21n where electrical power is in surplus to the extent of the surplus power.

In addition, the surplus power allocation calculation unit 206 supplies the surplus power or the insufficient power for each household 21n from the surplus power calculation unit 205 to the power demand calculation unit 207.

In step S126, the power demand calculation unit 207 calculates the power demand of the region 21, which is obtained by subtracting the total of the surplus power from the total of the insufficient power using the surplus power or the insufficient power for each household 21n from the surplus power allocation calculation unit 206, and supplies the power demand to the control unit 208.

In step S127, the control unit 208 controls the power plant (not shown) based on the power demand of the region 21 from the power demand calculating unit 207 and controls so as to supply a supply of electrical power with regard to the region 21 from the power plant with electrical power which is equal to or more than the total of the insufficient power.

In step S128, the control unit 208 controls the transformer 44 and the reactive power control device 45 based on the power demand of the region 21 from the power demand calculation unit 207 in the same manner as the control unit 103 of FIG. 5.

In addition, the control unit 208 controls the power conditioner 182 in the communication device 41n of the household 21n where electrical power is in surplus to the extent of the surplus power based on the allocation amount for each household 21n from the surplus power allocation calculation unit 206 and supplies the surplus power to the household 21m via the power detection unit 181 and the transmission lines. Due to this, the selling of the surplus power in the communication device 41n of the household 21n is able to be performed. This completes the third control process.

As described above, according to the third control process, since the power distribution control device 43 of FIG. 15 controls the power distribution in consideration of the surplus power in the household 21n, the insufficient power in the household 21m, and the like, it is possible to utilize the surplus power obtained from the household 21n without waste.

In addition, according to the third control process, since the surplus power of the household 21n is directly sent to the household 21m without being sent to the power plant, it is possible to reduce the loss of surplus power due to resistance components in the transmission lines.

Furthermore, in the case where the surplus power is sent from the household 21n to the household 21m, since it is possible to shorten the distance which the reactive power of the surplus power goes back and forth compared to a case of being sent from the household 21n to the power plant, it is possible to improve the use efficiency of the surplus power.

In the first to third embodiments described above, for ease of description, the region where the electrical power is supplied using the control of the power distribution control device 43 of FIGS. 5, 11, and 15 is described as only the region 21 as shown in FIG. 1, but it is possible to supply electrical power to a plurality of regions without being limited to the region 21.

However, in a case where the surplus power in the household 21n is sold, the performing of the selling may not be possible depending on the voltage value of the transmission lines.

<5. Fourth Embodiment>

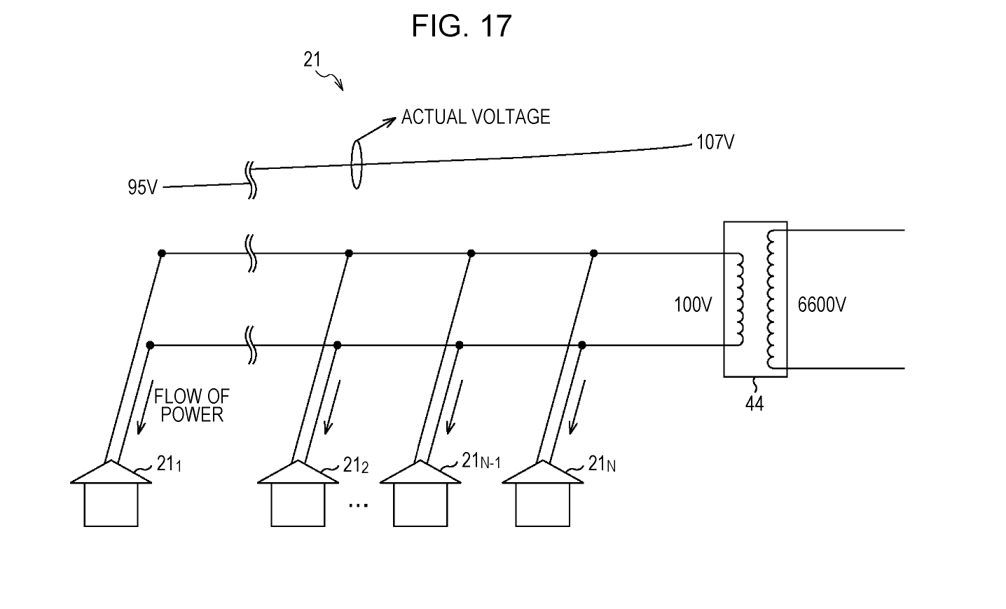

Next, one example will be described with reference to FIGS. 17 to 20 of a case where the power distribution control device 43 of FIG. 15 partitions or amalgamates the regions which are supplied with electrical power so that, for example, it is possible for surplus power in the households 211 to 21N and the liken to be sold without any problems.

Here, it is possible to configure the power distribution control devices 43 of FIGS. 5 and 11 in the same manner as the power distribution control device 43 of FIG. 15 so that the regions are partitioned or amalgamated. Accordingly, below, the power distribution control devices 43 of FIG. 15 will be described with regard to the partitioning and amalgamating of the regions and the description of the power distribution control devices 43 of FIGS. 5 and 11 is omitted.

FIG. 17 illustrates an example of a voltage value of electrical power which is supplied to the households 211 to 21N from a power plant via the transformer 44.

As shown in FIG. 17, for example, in the transformer 44 which is provided on a power pole in the region 21, electrical power is distributed at 6600 V from a power plant via the transmission lines. Then, the transformer 44 transforms the voltage of 6600 V which is input via the transmission lines so that the voltage value of the electrical power which is distributed to the households 211 to 21N included in the region 21 is equal to or less than 95 V and equal to or greater than 107 V.

That is, for example, the voltage of 6600 V which is input via the transmission lines is distributed to the households 211 to 21N by being transformed to a value close to the maximum permissible value of 107 V in consideration of the fall in voltage due to the resistance of the transmission lines, by the transformer 44. Here, the voltage distributed to the households 211 to 21N is determined in advance to be equal to or less than 95 V and equal to or greater than 107 V due to safety, the law, or the like.

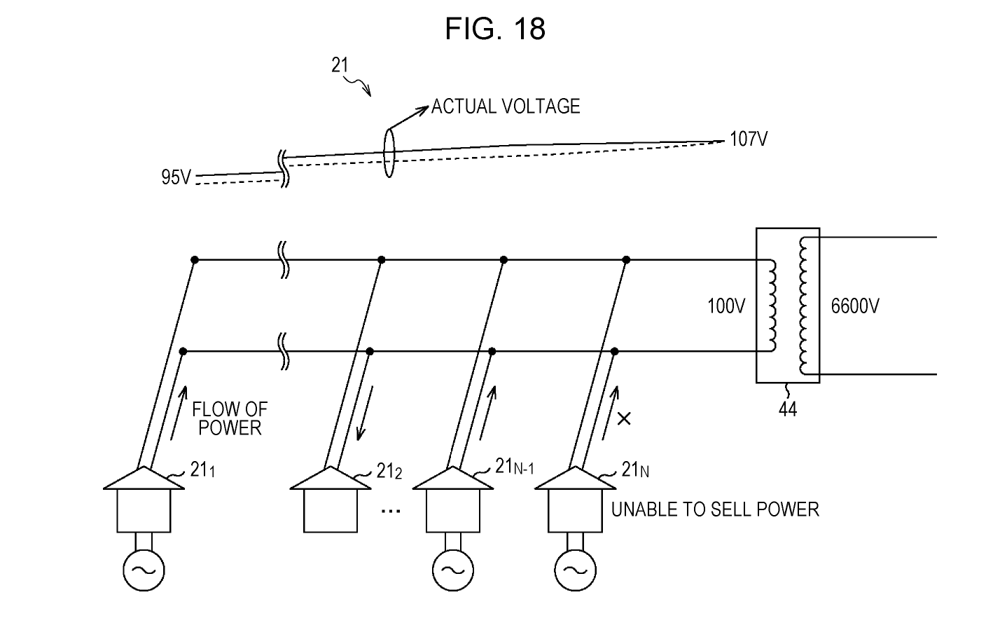

Next, FIG. 18 illustrates an example of a voltage value when electrical power is output from the households 211, 21N-1, 21N, and the like to the transmission lines in order to sell power.

In FIG. 18, for example, the households 211, 21N-1, and 21N have dispersed power sources such as solar panels.

In the households 211 to 21N, in a case where the selling of power is not performed, the voltage falls due to the resistance of the transmission lines in accordance with being farther away from the transformer 44 as shown by the dotted line in the upper part of FIG. 18.

However, in a case where the selling of power is performed in the households 211, 21N-1, 21N, and the like, the overall voltage rises as shown by the solid line in the upper part of FIG. 18.

That is, when the selling of surplus power is performed, for example, in a case where the surplus power is supplied directly from the household 211 to the household 212, it is necessary that the voltage value of the transmission lines which is drawn in by the household 211 is higher than the voltage value of the transmission lines which is drawn in by the household 212.

In this case, since the household 211 exists at the end (farthest away) when viewed from the transformer 44, the voltage value of the transmission lines which is drawn in by the household 211 is initially low. Accordingly, it is possible that the voltage value of the transmission lines which is drawn in by the household 211 is made to be higher than the voltage value of the transmission lines which is drawn in by the household 212 in the range of equal to or less than 95 V and equal to or greater than 107 V and it is possible to perform the selling of power without any problems.

On the other hand, since the households 21N-1 and 21N exist relatively close to the transformer 44, the voltage value of the transmission lines which is drawn in by the households 21N-1 and 21N is initially high, and if there is an attempt to increase the voltage value of the transmission lines which is drawn in by the households 21N-1 and 21N in order to perform the selling of power, the range of equal to or less than 95 V and equal to or greater than 107 V is exceeded. As a result, in regard to the households 21N-1 and 21N which exist close to the transformer 44, the selling of power may not be able to be performed.

Therefore, it is desirable that there is control in the power distribution control device 43 so that the voltage is in the range of equal to or less than 95 V and equal to or greater than 107 V even when increased when selling power so that the selling of power is able to be performed even with regard to either of the households 21N-1 and 21N.

Here, it is necessary that the power distribution control device 43 supplies electrical power with regard to a predetermined region with a supply amount according to the power demand of the predetermined region. Then, it is necessary that the power distribution control device 43 increases the voltage value of the electrical power in the transmission lines in order to supply more electrical power to the extent to which the power demand is larger.

When the voltage value of the electrical power in the transmission lines increases, the voltage value of the electrical power in the transmission lines exceeds the range of equal to or less than 95 V and equal to or greater than 107 V due to the selling of power in the household 21n and the like, and as a result, the selling of power may not be able to be performed.

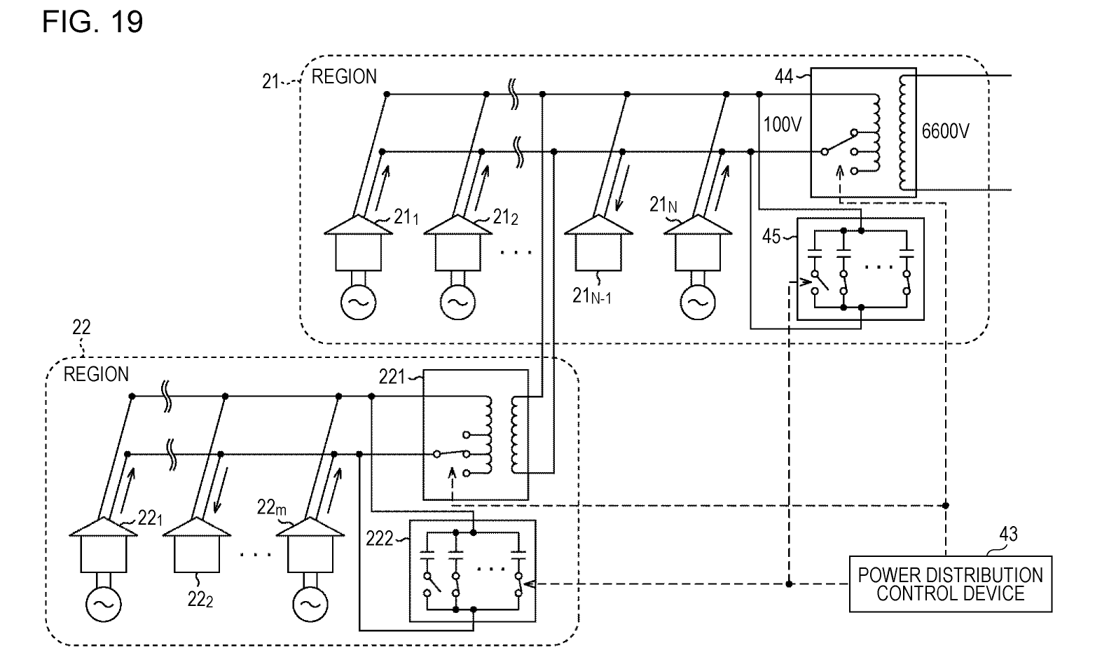

Next, FIG. 19 illustrates an example of a case where the selling of power is able to be performed without any problems by the power demand of the region which is the power distribution target being in a constant range due to the power distribution control device 43 partitioning or amalgamating a plurality of region and by the voltage being in the range of equal to or less than 95 V and equal to or greater than 107 V even when increased due to selling power or the like.

In a case of performing the supply of electrical power to the region 21 and a region 22 as one region, the power distribution control device 43 sets the transformation ratio of a transformer 221 as one to one and sets the power source of a reactive power control device 222 to be off and not to operate. Then, the power distribution control region 43 supplies the electrical power with regard to the one region which is configured from the region 21 and the region 22 by controlling the transformer 44 and the reactive power control device 45.

In addition, in a case of performing the supply of electrical power to the region 21 and the region 22 as separate regions, the power distribution control region 43 supplies the electrical power with regard to the region 21 in accordance with the power demand of the region 21 by controlling the transformer 44 and the reactive power control device 45. Furthermore, the power distribution control region 43 supplies the electrical power with regard to the region 22 in accordance with the power demand of the region 22 by controlling the transformer 221 and the reactive power control device 222.

Here, the primary side of the transformer 221 is connected to the transmission lines with a single phase 100 V as shown in FIG. 19, but it is not limited to this, and for example, may be connected to the transmission lines with 6600 V in the same manner as the primary side of the transformer 44.

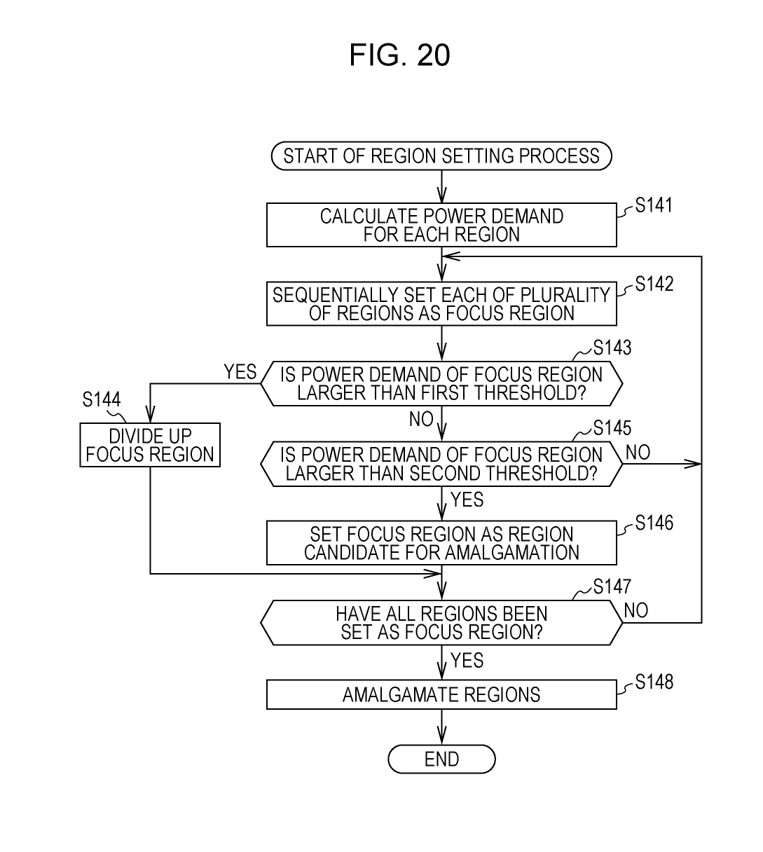

Next, a region setting process where the power distribution control device 43 of FIG. 19 performs the partition or the amalgamation of the regions in accordance with the power demand of the regions will be described with reference to the flowchart of FIG. 20.

The region setting process starts, for example, at a timing where the power demand is significantly changed during one day. That is, for example, the region setting process is performed a plurality of times in one day such as a timing where the power demand significantly increases (for example, at a timing where there is a change from morning to lunchtime), a timing where the power demand significantly decreases (for example, at a timing where there is a change from evening to late at night), and the like.

In step S141, the power demand calculation unit 207 (FIG. 15) of the power distribution control device 43 of FIG. 19 calculates the power demand for each of the plurality of regions and supplies the power demand to the control unit 208 in the same manner as the process of step S126 in the third control process.

In step S142, the control unit 208 sequentially sets each of the plurality of regions as the focus region and the process proceeds to step S143. In step S143, the control unit 208 determines whether or not the power demand of the focus region is larger than a first threshold which is determined in advance, and in a case where it is determined that the power demand of the focus region is larger than a first threshold, the process proceeds to step S144.

In step S144, the control unit 208 partitions the focus region into a plurality of regions. That is, for example, the control unit 208 partitions the focus region into the region 21 and the region 22 in a case where the one focus region is the region 21 and the region 22. Specifically, for example, the control unit 208 changes the transformation ratio of the transformer 221 to be one to one and operates the power source of the reactive power control device 222 to be on. After that, the process proceeds from step S144 to step S147. The process of step S147 will be described later.

In addition, in a case where the control unit 208 determines in step S143 that the power demand of the focus region is smaller than a first threshold, the process proceeds to step S145. In step S145, the control unit 208 determines whether the power demand of the focus region is smaller than a second threshold which is smaller than the first threshold and which is determined in advance. Then, in a case where the control unit 208 determines that the power demand of the focus region is larger than the second threshold, that is, in a case where it is determined that the power demand of the focus region is equal to or smaller than the first threshold and equal to or larger than the second threshold, the process proceeds to step S142.

Here, in step S142, the control unit 208 sets a region which has not yet been the focus region out of the plurality of regions as the new focus region and the process proceeds to step S143, and after that, the same process is repeated.

In addition, in a case where the control unit 208 determines in step S145 that the power demand of the focus region is smaller than the second threshold, the process proceeds to step S146, the focus region is set as a candidate region for amalgamation, and the process proceeds to step S147.

In step S147, the control unit 208 determines whether or not all of the plurality of regions have been set as the focus region, and in a case where there is a region which has not yet been set as the focus region, the process returns to step S142, and after that, the same process is repeated.

In addition, in a case where the control unit 208 determines in step S147 that all of the plurality of regions have been set as the focus region, the process proceeds to step S148, the regions which are candidate regions for amalgamation in the process of step S146 are amalgamated, and regions, where the power demand is equal to or smaller than the first threshold and equal to or larger than the second threshold, are formed. This completes the region setting process.

As described above, according to the region setting process, each of the regions are set as regions where the power demand is equal to or smaller than the first threshold and equal to or larger than the second threshold by partitioning or amalgamating so that the voltage value is in the range of equal to or less than 95 V and equal to or greater than 107 V even when increased due to selling power or the like.

Accordingly, it is possible to perform the selling of power without any problems in any region. In addition, for example, in a time slot when the power demand is low in all of the plurality of regions, the region 21 and the region 22 are set as one large region as shown, for example, in FIG. 19.

In this case, the power distribution control device 43 may only control the transformer 44 and the reactive power control device 45 when performing control of the power distribution. As a result, it is possible to reduce the processing due to the controlling in comparison to a case where it is necessary to control the transformer 221 and the reactive power control device 222 along with the transformer 44 and the reactive power control device 45 in order that the region 21 and the region 22 are separate regions.

<6. Fifth Embodiment>

In the first embodiment described above, the power distribution control device 43 calculates the power demand based on the composite value of the impedance, but the power demand may be calculated based on whether or not a user exists in their household 21n.

Next, a power distribution control system 1, which is configured from the communication device 41n which transmits at-home information which expresses whether or not the user is at home, the power distribution control device 43 which calculates the power demand based on the at-home information from the communication device 41n, the transformer 44, and the reactive power control device 45, will be described with reference to FIGS. 21 to 24.

[Fourth Configuration Example of Communication Device 41n]

FIG. 21 illustrates a configuration example of the communication device 41n which transmits at-home information.

Here, the communication device 41n of FIG. 21 is configured in the same manner as the communication device 41n of FIG. 2 other than an at-home recognition signal transmission unit 241 and an at-home information reception unit 242 are newly provided and a communication unit 243 is provided instead of the communication device 84 of FIG. 2. In the portions which are configured in the same manner, the description is appropriately omitted since the same reference numerals are attached.

The at-home recognition signal transmission unit 241 outputs an at-home recognition signal which represents a wireless signal for determining whether or not the user exists in the household 21n.

Here, the resident (user) who lives in the household 21n normally holds a mobile terminal. The mobile terminal determines whether or not the user is at home based on whether or not the at-home recognition signal is received with a reception strength which is equal to or greater than a predetermined appropriate threshold and the at-home information which expresses the determination result is transmitted to the at-home information reception unit 242 of the communication device 41n of FIG. 21.

That is, for example, in a case where the mobile terminal determines that the reception strength of the received at-home recognition signal is equal to or greater than the predetermined threshold, that is, in a case where it is determined that the mobile terminal which is held by the user exists in the household 21n, it is determined that the user exists in the household 21n. In this case, the mobile terminal generates the at-home information which expresses that the user is at home and the at-home information is transmitted to the at-home information reception unit 242.

In addition, for example, in a case where the mobile terminal determines that the reception strength of the received at-home recognition signal is not equal to or greater than the predetermined threshold (or a case where the at-home recognition signal is not able to be received (a case where the reception strength is zero)), that is, in a case where it is determined that the mobile terminal which is held by the user does not exist in the household 21n, it is determined that the user does not exists in the household 21n. In this case, the mobile terminal generates the at-home information which expresses that the user is not at home and the at-home information is transmitted to the at-home information reception unit 242.

The at-home information reception unit 242 receives the at-home information from the mobile terminal and supplies the at-home information to the communication unit 243.

The communication unit 243 supplies the at-home information from the at-home information reception unit 242 to the power distribution control device 43 of FIG. 23 via the network 42 along with performing the processes in the same manner as the communication unit 84 of FIG. 2.

With regard to this, the power distribution control device 43 of FIG. 23 acquires the composite value for each household 21n using the history information where the composite values of the device grouping 61 are accumulated according to whether or not the user is at home based on the at-home information supplied via the network 42.

Then, the power distribution control device 43 of FIG. 23 calculates the power consumption for each household 21n based on the acquired composite value for each household 21n and calculates the total of the calculated power consumption as the power demand of the region 21.

Here, the history information which is accumulated in the power distribution control device 43 of FIG. 23 is accumulated by the at-home information and the composite value being supplied with regard to the power distribution control device 43 of FIG. 23 from the communication unit 243. Before the history information is accumulated, the impedance transmission process of FIG. 4 is performed in the communication device 41n of FIG. 21 and the first control process which was described using FIG. 6 is performed in the power distribution control device 43 of FIG. 23.

Then, for example, after the history information is accumulated in the power distribution control device 43 of FIG. 23, the communication device 41n of FIG. 21 performs an at-home information transmission process.

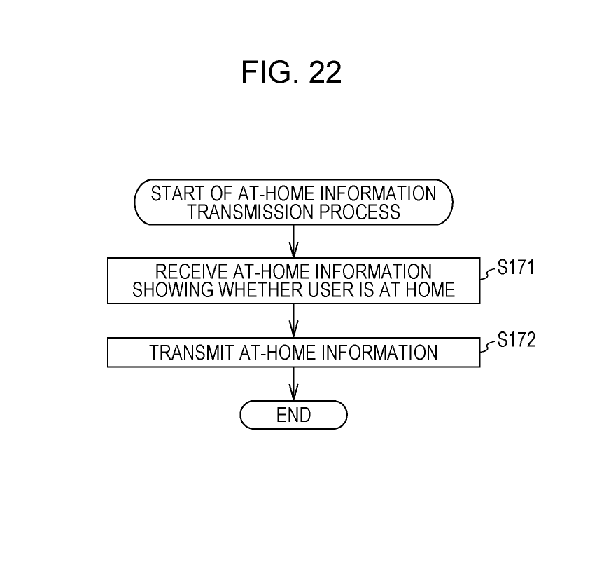

Next, the at-home transmission process which is performed by the communication device 41n of FIG. 21 will be described with reference to FIG. 22.

In step S171, the at-home information reception unit 242 receives the at-home information from the mobile terminal which is held by the user and supplies the at-home information to the communication unit 243.

In step S272, the communication unit 243 supplies the at-home information from the at-home information reception unit 242 to the power distribution control device 43 of FIG. 23 via the network 42. This completes the at-home information transmission process.

As described above, according to the at-home information transmission process, it is possible for the power demand to be calculated in the power distribution control device 43 of FIG. 23 by only the communication device 41n of FIG. 21 transmitting the at-home information.

[Fourth Configuration of Power Distribution Control Device 43]

Next, FIG. 23 illustrates a configuration example of the power distribution control device 43 which calculates the power demand based on the at-home information from the communication device 41n of FIG. 21.

The power distribution control device 43 of FIG. 23 is configured from a communication device 261, a power demand calculation unit 262, a history information storage unit 263, and a control unit 264.

The communication unit 261 receives the at-home information from the communication device 41n of FIG. 21 via the network 42 and the at-home information is supplied to the power demand calculation unit 262.

The power demand calculation unit 262 calculates each composite value of the device grouping 61 provided in the household 21n by referencing the history information which is accumulated in the history information storage unit 263 based on the at-home information for each communication device 41n from the communication unit 261.

Specifically, for example, in a case where the at-home information which expresses whether or not the user is at home is acquired, the power demand calculation unit 262 calculates the average value, median value, or the like of the composite value which is transmitted when the user is at home as the composite value of the device grouping 61 provided in the household 21n based on the history information.

In addition, the power demand calculation unit 262 calculates the power consumption for each household 21n based on each composite value for each household 21n. Then, the power demand calculation unit 262 supplies the total of the calculated power consumption for each household 21n to the control unit 264 as the power demand of the region 21.

The history information storage unit 263 stores the history information which expresses the history of the composite values which are transmitted in a case where the user is at home, the composite values which are transmitted in a case where the user is not at home, and the like in regard to each household 21n in the region 21. Here, the history information is created and accumulated based on, for example, the at-home information and the composite value from the communication device 41n.

The control unit 264 performs control in the same manner as the control unit 103 of FIG. 5 based on the power demand from the power demand calculation unit 262.

Here, the history information storage unit 263 may store an operational state of each of the electrical appliances which configure the device grouping 61 of the household 21n in a case where the user is at home and an operational state of each of the electrical appliances which configure the device grouping 61 of the household 21n in a case where the user is not at home as the history information.

That is, for example, it is possible that the history information storage unit 263 stores the operational states of the electrical appliances (for example, whether or not the electrical appliances have their power on) which corresponds to the device IDs as the history information. In addition, for example, the history information storage unit 263 may store the operational states of the electrical appliances which corresponds to the device IDs and the mode IDs as the history information.

In this case, the power demand calculation unit 262 detects the operational state (and the corresponding device Id and mode ID) of the device grouping 61 for each household 21n by referencing the history information which is stored in the history information storage unit 263 based on the at-home information for each communication device 41n from the communication unit 261.

That is, for example, the power demand calculation unit 262 detects the operational state of each of the electrical appliances which configures the device grouping 61 as the operational state of the device grouping 61 for each household 21n. Specifically, for example, in a case where the at-home information which expresses that the user is at home is acquired, the power demand calculation unit 262 detects the operational state, which is most frequently accumulated as the operational state out of the operational states (corresponding to the device IDs or the device IDs and the mode IDs) when the user is at home, for each of the electrical appliances.

Then, the power demand calculation unit 262 calculates each composite value of the device grouping 61 provided in each household 21n using the table described using FIGS. 3 and 7 based on the detected operational state of the device grouping 61. Then, the power demand calculation unit 262 calculates the power consumption of each household 21n based on each composite value of the device grouping 61 of each household 21n. The power demand calculation unit 262 supplies the total of the calculated power consumption of each household 21n as the power demand of the region 21 to the control unit 264.

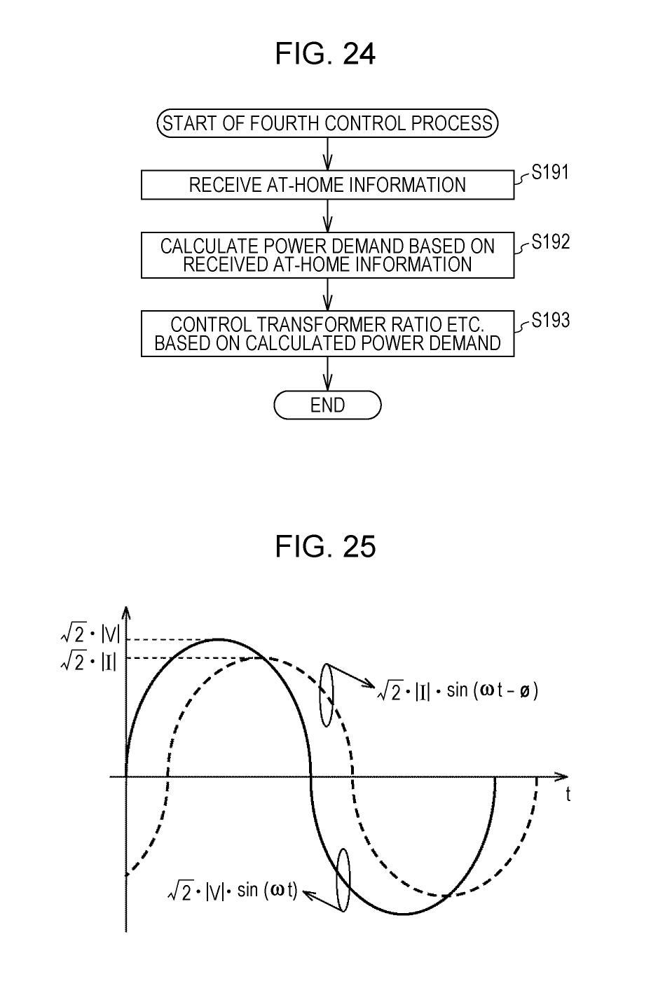

Next, a process (referred to below as a fourth control process) where the power distribution control device of FIG. 23 controls the transformer 44 and the reactive power control device 45 will be described with reference to the flowchart of FIG. 24.

In step S191, the communication unit 261 receives the at-home information which is supplied from the communication device 41n of FIG. 21 via the network 42 and supplies the at-home information to the power demand calculation unit 262.

In step S192, the power demand calculation unit 262 calculates each composite value of the device grouping 61 provided in each household 21n by referencing the history information which is stored in the history information storage unit 263 based on the at-home information for each communication device 41n from the communication unit 261. In addition, the power demand calculation unit 262 calculates the power consumption for each household 21n based on each composite value for each household 21n. Then, the power demand calculation unit 262 supplies the total of the calculated power consumption for each household 21n to the control unit 264 as the power demand of the region 21.

In step S193, the control unit 264 performs control in the same manner as the control unit 103 of FIG. 5 based on the power demand from the power demand calculation unit 262. This completes the fourth control process.

As described above, according to the fourth control process, since the power demand is calculated based on the history information, only the at-home information which expresses whether or not the user is at home may be transmitted in the communication device 41n of FIG. 21.

Here, in the fifth embodiment, the impedance calculation unit 82 and the table storage unit 83 are provided in the communication device 41n of FIG. 21 in consideration of a case where the history information is not accumulated in the history information storage unit 263 of the power distribution control device 43 of FIG. 23.

However, in a case such as where the history information is accumulated in advance in the history information storage unit 263, it is possible for the communication device 41n of FIG. 21 to omit the impedance calculation unit 82 and the table storage unit 83 and only be configured by the power detection unit 81, the at-home recognition signal transmission unit 241, the at-home information reception unit 242, and the communication unit 243.

In addition, the mobile terminal held by the user may be any terminal if the at-home information is generated and transmitted based on the received at-home recognition signal. That is, for example, it is possible to adopt a wireless LAN (local area network) communication terminal which is able to connect to the Internet or the like via a wireless LAN access point, or a mobile phone or the like.

Furthermore, for example, in a case where the user holds a wireless LAN communication terminal as the mobile terminal, a wireless LAN access point which outputs a beacon signal as the at-home recognition signal may be provided instead of the communication device 41n of FIG. 21.

In this case, the wireless LAN communication terminal generates the at-home information based on whether or not the beacon signal is able to be received at a reception strength which is equal to or greater than a predetermined threshold from the wireless LAN access point and transmits (replies with) the at-home information to the wireless LAN access point. Then, the wireless LAN access point transmits the at-home information from the wireless LAN communication terminal to the power distribution control device 43 of FIG. 23.

In addition, for example, in a case where the user holds a mobile phone as the mobile terminal, a femtocell for mobile phones (small-scale base station) which outputs a payload signal as the at-home recognition signal may be provided instead of the communication device 41n of FIG. 21.

In this case, the mobile phone generates the at-home information based on whether or not the payload signal is able to be received at a reception strength which is equal to or greater than a predetermined threshold from the femtocell and transmits the at-home information to the at-home information reception unit 242. Then, the femtocell transmits the at-home information from the mobile phone to the power distribution control device 43 of FIG. 23. Here, it is needless to say that it is possible to use the signal which accompanies the position registration process with regard to the femtocell or the position management information as the at-home information.

Here, in a case where the wireless LAN access point or the femtocell is provided in the household 21n instead of the communication device 41n of FIG. 21, the history information is still accumulated in the history information storage unit 263.

Furthermore, for example, the mobile terminal held by the user transmits the at-home information via the communication device 41n of FIG. 21, but the at-home information may be transmitted to the power distribution control device 43 of FIG. 23 without going via the communication device 41n of FIG. 21. This is the same as in the case where the wireless LAN access point or the femtocell is adopted instead of the communication device 41n of FIG. 21.

In addition, in the fifth embodiment, the power distribution control device 43 of FIG. 23 holds the history information, but the communication device 41n of FIG. 21 may hold the history information with regard to the communication device 41n.

In this case, in the communication device 41n of FIG. 21, it is determined whether or not the user is at home based on the at-home information from the mobile terminal and the composite value is calculated by referencing the history information and the like which is held based on the determination result in the same manner as the power demand calculation unit 262 of FIG. 23. Then, the communication device 41n of FIG. 21 transmits the calculated composite value to the power distribution control device 43 (for example, the power distribution control device 43 of FIG. 5 and the like) which controls the power distribution by calculating the power demand based on the composite value from the communication device 41n of FIG. 21.

In addition, it is possible that the communication device 41n of FIG. 21 determines using another determination method other than determining whether or not the user is at home based on the received at-home information.

That is, for example, in the communication device 41n of FIG. 21, a movement detection sensor which detects the movement of objects (for example, the user) which are in a predetermined range of the household 21n and it is possible to determine whether or not the user is at home according to whether or not the movement of an object is detected using the movement detection sensor.

Other than this, for example, in the communication device 41n of FIG. 21, a camera which images a predetermined range of the household 21n may be provided and whether or not the user is at home may be determined according to whether or not the user is able to be detected from the imaging image which is obtained using the imaging of the camera.

In addition, in the fifth embodiment, the mobile terminal which is held by the user generates the at-home information which shows whether or not the user is at home based on whether or not the at-home recognition signal is able to be received at a reception strength which is equal to or more than the predetermined threshold but the method for generating the at-home information is not limited to this.

That is, for example, in a case where the mobile phone is adopted as the mobile terminal which is held by the user, it is possible to generate the at-home information based on a payload signal which is received from each of a femtocell provided in the household 21n and a public base station or the like which is disposed outside.

Specifically, for example, in a case where it is determined that the reception strength of the payload signal from the femtocell provided in the household 21n is the largest out of a plurality of payload signals which are received, the mobile phone generates the at-home information which shows that the user is at home. In addition, for example, in a case where it is determined that the reception strength of the payload signal from the public base station is the largest out of a plurality of payload signals which are received, the mobile phone generates the at-home information which shows that the user is not at home.

However, for example, even in a case where the user exists in the household 21n, the electrical appliances which consume electrical power are different according to which space the user exists in out of a plurality of spaces (for example, rooms such as the living room, the bedroom, or the like) which configure the household 21n.

That is, for example, in a case where the user exists in the living room of the household 21n, there is a high possibility that the electrical appliances (included in the device grouping 61) which are provided in the living room will consume electrical power. In addition, for example, in a case where the user exists in the bedroom of the household 21n, there is a high possibility that the electrical appliances which are provided in the bedroom will consume electrical power.

As a result, in the power distribution control device 43 of FIG. 23, it is desirable that the power demand calculation unit 262 calculates the power consumption for each household 21n based on the current position of the user along with whether or not the user is at home in the household 21n.

In a case where the power demand calculation unit 262 calculates the power consumption for each household 21n based also on the current position of the user, the current position (the current position of the user) is detected using a measurement unit such as GPS (Global Positioning System) in a mobile phone when the mobile phone receives a payload signal from a femtocell, a public base station, or the like and the current position is transmitted to the power distribution control device 43 of FIG. 23 by including the current position in the at-home information.

Then, the power distribution control system 43 of FIG. 23 calculates the power consumption of the household 21n by referencing the history information and the like which is stored in the history information storage unit 263 based on also the current position of the user which is included in the at-home information along with the at-home information. Here, in this case, in the history information storage unit 263, the composite value and the like are stored with regard to the electrical appliance which is used when the user is in a space for each of the plurality of spaces (for example, the bedroom, the living room, and the like) which configure the household 21n.

In the fifth embodiment, in the mobile terminal which is held by the user, the at-home information is generated and transmitted irrespective of whether or not the user is at home, but only when the user is at home, the at-home information which shows that the user is at home may be generated and transmitted.

In this case, for example, in a case where the at-home information which shows the user is at home is received from the mobile terminal, the communication device 41n of FIG. 21 transmits the received at-home information, and in a case where the at-home information is not received from the mobile terminal, the communication device 41n of FIG. 21 generates and transmits the at-home information which shows that the user is not at home.

This may be said to be the same as a case where, only in a case where the user is not at home, the at-home information which shows that the user is not at home is generated and transmitted in the mobile terminal.

In the fifth embodiment, the mobile terminal which is held by the user generates the at-home information base on whether or not the at-home recognition signal is able to be received from the communication device 41n of FIG. 21 at a reception strength which is equal to or greater than the predetermined threshold. However, for example, the communication device 41n of FIG. 21 may generate the at-home information itself and transmit the at-home information to the power distribution control device 43 of FIG. 23 via the network 42.

That is, for example, it is possible that the mobile terminal which is held by the user transmits the at-home recognition signal and the communication device 41n of FIG. 21 generates the at-home information based on whether or not the at-home recognition signal is received from the mobile terminal at a reception strength which is equal to or greater than the predetermined threshold and transmits the at-home information to the power distribution control device 43 of FIG. 23.

Other than this, for example, the communication device 41n of FIG. 21 may determine whether or not the user is at home based on the movement detection sensor or the imaging image which is output from a camera which images a predetermined range in the household 21n as described above, may generates the at-home information based on the determination result, and may transmit the at-home information to the power distribution control device 43 of FIG. 23.

Here, in a case where a femtocell or a wireless LAN access point is adopted instead of the communication device 41n of FIG. 21, it is possible for the femtocell or the wireless LAN access point to generate the at-home information in the same manner.

<7. Sixth Embodiment>

Here, in the first embodiment described above, for example, the impedance calculation unit 82 calculates the impedance of the electrical appliances and the like using the table such as that shown in FIG. 3, but a current which flows in and a voltage which is applied to the electrical appliances and the like may be detected and the impedance of the electrical appliances and the like may be calculated based on the detected current and voltage.

FIG. 25 illustrates an example of a current and a voltage.

In FIG. 25, the horizontal axis is represented by time t and the vertical axis is represented by a current value and a voltage value which change according to time. Here, an AC current changes over a predetermined cycle and is expressed by the function √2×|I|×sin(ωt−φ) which is shown by the solid line. In addition, the voltage of the alternating current changes over a predetermined cycle and is expressed by the function √2×|V|×sin(ωt) which is shown by the dashed line. Here, I represents current and V represents voltage. In addition, ω represents angular speed.

The current which is represented by the function √2×|I|×sin(ω−φ) and the voltage which is represented by the function √2×|V|×sin(ωt) are different by only the phase φ.

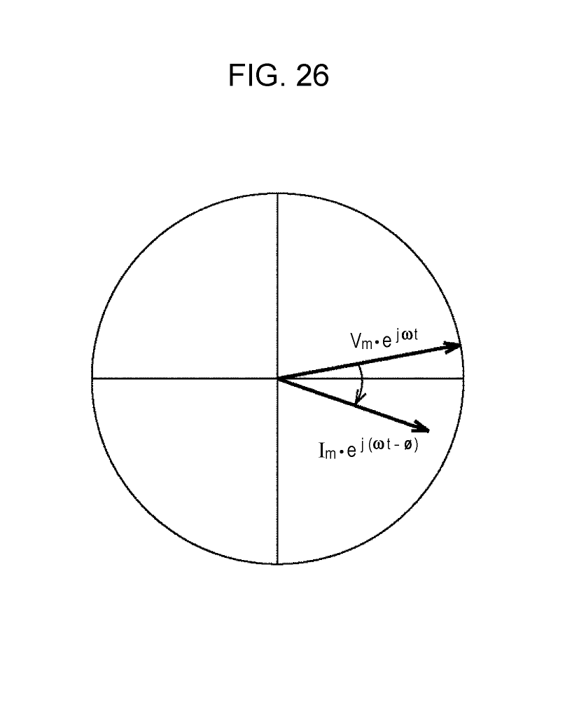

When the functions shown in FIG. 25 are represented using polar coordinates, the current is represented by the function Im×ej(ωt−φ) and the voltage is represented by the function Vm×ejωt as shown in FIG. 26. Here, j represents an imaginary number.

The impedance calculation unit 82 calculates an impedance Z using equation (1) based on the function Im×ej(wt−φ) which corresponds to the detected current and the function Vm×ejωt which corresponds to the detected voltage.

Z=V/I=(|V|×ejωt)/(|I|×ej(ωt−φ))=(|V|/|I|)×ejφ=(|V|/|I|)×(cos φ+j sin φ) (1)

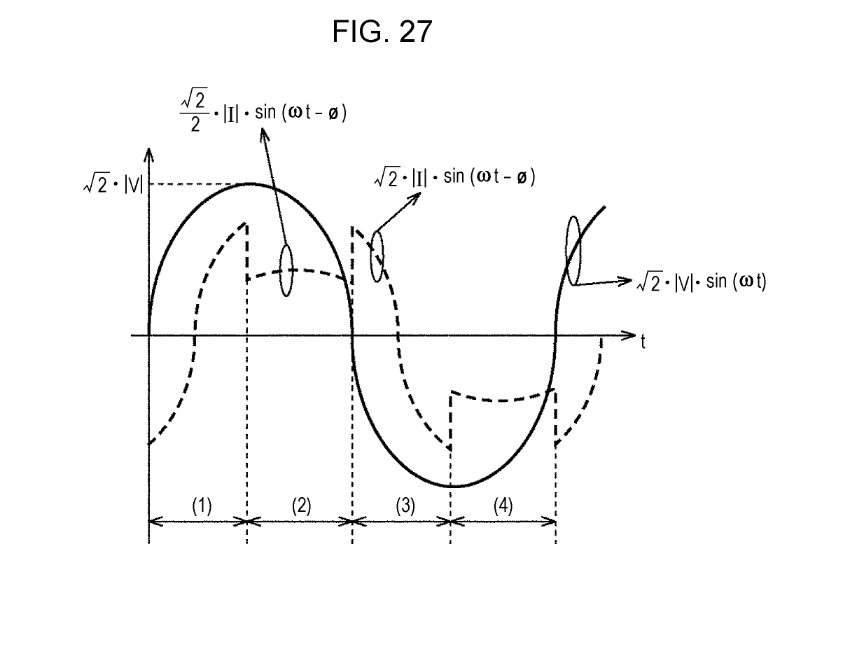

In addition, in a case where the detected current does not become a sine wave as shown in FIG. 25, the impedance calculation unit 82 performs time division of one cycle of the function Vm×ejωt which corresponds to the detected voltage over into a plurality of sections as shown in FIG. 27 and it is possible for the impedance Z to be calculated for each of the plurality of sections obtained by the dividing over time.

Next, FIG. 27 illustrates an example of a case where one cycle of the function Vm×ejωt which corresponds to the detected voltage is time divided into four sections and the impedance Z is calculated for each of the four sections.

In FIG. 27, the function √2×|V|×sin(ωt) where one cycle is time divided in four sections (1), (2), (3), and (4) is shown as the function which shows the voltage. In addition, in FIG. 27, the function (√2/2)×|I|×sin(ωt−φ) is shown in sections (1) and (3) and the function √2×|I|×sin(ωt−φ) is shown in sections (2) and (4) as the function which shows the AC current.

The impedance calculation unit 82 calculates Z1=(|V|/|I|)×(cos φ+j sin φ) as the impedance Z in sections (1) and (3) and calculates Z2=(2×|V|/|I|)×(cos φ+j sin φ) as the impedance Z in sections (2) and (4).

Then, the impedance calculation unit 82 calculates the composite value of the impedance based on each impedance calculated for each section and supplies the composite value to the communication unit 84.

In this manner, it is possible for the impedance calculation unit 82 to accurately calculate the composite value even if the AC current is not an exact sine wave when the composite value is calculated by calculating the impedance for each section.

<8. Modified Examples>

Here, for ease of description, the dispersed power source 124 (FIG. 8) has been described as one of a solar panel or a storage battery.

However, as described above, it is possible for the dispersed power source 124 to be, for example, a solar panel 281 and a storage battery 282 as shown in FIG. 28.

Here, in FIG. 28, the solar panel 281 generates power by receiving light such as sunlight and supplies electrical power obtained by power generation to the storage battery 282.

The storage battery 282 stores the electrical power from the solar panel 281. That is, the storage battery 282 is charged using the electrical power from the solar panel 281.

In addition, the storage battery 282 supplies the stored electrical power to the power conditioner 123.

Here, in FIG. 28, in a case where the storage battery 282 is finished charging (in a case of charging to the maximum amount of possible charging), the electrical power which is obtained due to the power generation of the solar panel 281 may also be supplied to the power conditioner 123 as shown in FIG. 29. Then, in a case where the storage amount of the storage battery 282 is less than a predetermined threshold (for example, 80% of the maximum amount of possible charging), the electrical power which is obtained due to the power generation of the solar panel 281 may be supplied to the storage battery 282 and stored.

Next, FIG. 29 illustrates a configuration example of the dispersed power source 124 in a case where at least one of the solar panel 281 and the storage battery 282 supplies electrical power with regard to the power conditioner 123.

Here, in FIG. 29, in regard to portions which are configured in the same manner as the dispersed power source 124 of FIG. 28, the description is appropriately omitted below since the same reference numerals are attached.

That is, the dispersed power source 124 of FIG. 29 is configured in the same manner as the dispersed power source 124 of FIG. 28 other than a control unit 291 is newly provided between the solar panel 281 and the storage battery 282.

Here, electrical power is supplied from the solar panel 281 in the control unit 291. For example, the control unit 291 detects the storage amount of the storage battery 282 based on the electrical power charged from the storage battery 282.

Then, the control unit 291 determines whether or not the detected storage amount is less than a predetermined threshold, and in a case where it is determined that the storage amount is less than the predetermined threshold, the electrical power from the solar panel 281 is supplied to the storage battery 282 and the charging of the storage battery 282 is performed. In this case, for example, only the storage battery 282 supplies electrical power to the power conditioner 123.

Here, the supply from the solar panel 281 to the storage battery 282 is performed until the charging of the storage battery 282 is finished.

In addition, in a case where the detected storage amount is not less than the predetermined threshold, the control unit 291 supplies the electrical power from the solar panel 281 to the power conditioner 123. In this case, the solar panel 281 and the storage battery 282 supply electrical power to the power conditioner 123.

Here, in a case where the storage amount of the storage battery 282 is extremely low, the control unit 291 may supply the electrical power from the solar panel 281 to the power conditioner 123 when the supplying of electrical power to the power conditioner 123 is necessary. In this case, only the electrical power from the solar panel 281 is supplied to the power conditioner 123.

Here, it is possible to configure the dispersed power source 183 of FIG. 13 in the same manner as the dispersed power source 124 in FIGS. 28 and 29.

In addition, for example, in FIG. 13, in a case where the dispersed power source 183 is one of the solar panel or the storage battery, the power conditioner 182 detects the generation amount of the dispersed power source 183 as the amount of electrical power of the electrical power which is generated from the dispersed power source 183 and consumed by the load.

However, the power conditioner 182 may detect any amount which represents the amount of electrical power of the electrical power which is generated from the dispersed power source 183 and consumed by the load.

That is, for example, in a case where the dispersed power source 183 is the storage battery, the power conditioner 182 may detect the storage amount of the electrical power which is stored in the dispersed power source 183 which is the storage battery as the amount of electrical power of the electrical power which is generated from the dispersed power source 183 and consumed by the load.

In this case, instead of the generation amount, the storage amount is stored in the generation amount storage unit 184 in FIG. 13 and the storage amount which is stored in the generation amount storage unit 184 is supplied to the power distribution control device 43 of FIG. 15 via the network 42 using the communication unit 187. Then, in the power distribution control device 43 of FIG. 15, the reactive power calculation unit 205 calculates the surplus power or insufficient power for each household 21n based on the storage amount of each communication device 41n from the communication unit 201 and the power consumption for each household 21n from the power consumption calculation unit 204.

This is the same as the case where the dispersed power source 183 in FIG. 13 is configured as the dispersed power source 124 shown in FIG. 28. In addition, in a case where the dispersed power source 183 in FIG. 13 is configured as the dispersed power source 124 shown in FIG. 29, it is the same when electrical power is supplied only from the storage battery 282 with regard to the power conditioner 182.

Furthermore, in a case where the dispersed power source 183 in FIG. 13 is configured as the dispersed power source 124 shown in FIG. 29, the generation amount is detect in the power conditioner 182 when electrical power is supplied only from the solar panel 281 with regard to the power conditioner 182.

In addition, in a case where the dispersed power source 183 in FIG. 13 is configured as the dispersed power source 124 shown in FIG. 29, the generation amount of the solar panel 281 and the storage amount (or generation amount) of the storage battery 282 is detect in the power conditioner 182 when electrical power is supplied from the solar panel 281 and the storage battery 282 with regard to the power conditioner 182.

The generation amount of the solar panel 281 and the storage amount (or generation amount) of the storage battery 282 are transmitted to the power distribution control device 43 of FIG. 15 and is used when calculating the surplus power or insufficient power of the household 21n in the surplus power calculation unit 205 of FIG. 15.

Here, in a case where the generation of power is performed in the dispersed power source 124, the performing of the generation of power is described to include the solar panel in the dispersed power source 124. However, a power generation device, which is provided as a portion of the dispersed power source 124 and which performs the generation of power, is not limited to the solar panel.

That is, for example, there may be any device used as the power generation device as long as it is a relatively small-scale device which is able to be provided at a house. Specifically, for example, it is possible to adopt a power generator which performs the generation of power by burning gas, kerosene, and the like, a power generator which generates power using wind power, or the like as the power generation device. This may be said as being the same for the dispersed power source 183.

Here, it is possible for the disclosure to take the following configurations.

(1) A communication device is a communication device which communicates with a power distribution control device which controls power distribution with regard to a region which is a power distribution target and includes an acquisition unit which acquires calculation information for calculating electrical power which is to be distributed with regard to the region and a transmission unit which transmits the calculation information to the power distribution control device.

(2) The communication device described in (1) where the acquisition unit calculates and acquires a composite value of impedance of a load which consumes electrical power in a predetermined space which is provided in a region as the calculation information, and the transmission unit transmits the composite value to the power distribution control device.

(3) The communication device described in (2) where the acquisition unit calculates a composite value of impedance of a load which has its power on out of a plurality of loads which exist in the predetermined space and calculates the composite value using the impedance obtained based on an operation mode of the load with regard to loads where the impedance changes in accordance with the operation of the load.

(4) The communication device described in (3) where the acquisition unit calculates the composite value using the impedance obtained based on identification information for uniquely identifying the load with regard to loads where the impedance is constant irrespective of the operation of the load.

(5) The communication device described in (1) to (4) where, in a case where a function which expresses the AC current flowing in the load changes over a predetermined cycle, the acquisition unit calculates the impedance of the load for each AC current which is expressed using the same function and calculates the composite value using the calculated plurality of impedances.

(6) The communication device described in (1) to (4) where a determination unit, which determines whether or not a user exists in the predetermined space, and a history information holding unit, which holds information on the loads in cases where the user exists in the predetermined space and information on the loads in cases where the user does not exist in the predetermined space as past history information, are further provided, where the acquisition unit calculates the composite value of the impedance of the loads using the history information held in the history information holding unit based on the determination result of whether or not the user exists in the predetermined space.

(7) The communication device described in (2) where the acquisition unit calculates a composite value which expresses the impedance of all of the plurality of loads using a table where the impedance of the loads correspond to each of the plurality of loads.

(8) The communication device described in (1) to (4) where a power source unit, which generates its own power which is consumed by the load, and a detection unit which, detects the amount of electrical power of the electrical power generated by the power source unit and consumed by the load, are further provided, where the transmission unit transmits the composite value and the amount of electrical power to the power distribution control device.

(9) The communication device described in (8) where the power source unit is formed by at least one of a power storage unit which generates electrical power which has been stored and a power generating unit which generates electrical power by generating power.

(10) The communication device described in (9) where the power storage unit stores electrical power obtained by generating power.

(11) The communication device described in (1) where the acquisition unit acquires identification information for uniquely identifying the loads which consume electrical power in the predetermined space as the calculation information and the transmission unit transmits the identification information to the power distribution control device.

(12) The communication device described in (11) where the acquisition unit also acquires the identification information and mode information which shows an operation mode of the load as the calculation information and the transmission unit transmits the identification information and the mode information to the power distribution control device.

(13) A communication method of a communication device communicating with a power distribution control device which controls power distribution with regard to a region which is a power distribution target, and includes acquiring calculation information for calculating electrical power which is to be distributed with regard to the region and transmitting the calculation information to the power distribution control device, using the communication device.

(14) A program for making a computer, which is a communication device which communicates with a power distribution control device which controls power distribution with regard to a region which is a power distribution target, function as an acquisition unit which acquires calculation information for calculating electrical power which is to be distributed with regard to the region and a transmission unit which transmits the calculation information to the power distribution control device.

(15) A power distribution control device is a power distribution control device which controls power distribution with regard to a region which is a power distribution target, and includes a reception unit which receives calculation information for calculating electrical power which is to be distributed to the region from a communication device which communicates with the power distribution control device, a power calculation unit which calculates the electrical power which is to be distributed to the region based on the received calculation information, and a power distribution control unit which performs power distribution with regard to the region based on the calculated electrical power.

(16) The power distribution control device described in (15) where the power calculation unit calculates the electrical power which is to be distributed to each of a plurality of regions, and the power distribution control unit partitions or amalgamates the regions which are power distribution targets based on the electrical power which is to be distributed to each of the plurality of regions and performs power distribution with regard to the regions after partition or amalgamation.

(17) The power distribution control device described in (16) where the reception unit receives a composite value of impedance of a load which consumes electrical power in a predetermined space which is provided in a region as the calculation information, and the power calculation unit calculates the electrical power which is to be distributed with regard to the region based on the received composite value.

(18) The power distribution control device described in (17) where the reception unit receives an amount of electrical power which is generated by the communication device itself as the calculation information, and the power calculation unit calculates the electrical power which is to be distributed with regard to the region based on the received composite value and the amount of electrical power.

(19) The power distribution control device described in (16) where there are loads which consume electrical power in the predetermined space provided in the region, a history information holding unit, which holds information on the loads in cases where a user exists in the predetermined space and information on the loads in cases where a user does not exist in the predetermined space as past history information, is further provided, the reception unit receives location information which shows whether or not the user exists in the predetermined space, and the power calculation unit calculates the electrical power which is to be distributed with regard to the region using the history information which is held by the history information holding unit based on the received location information.

(20) The power distribution control device described in (16) where the reception unit receives identification information for uniquely identifying the loads which consume electrical power in the predetermined space provided in the region as the calculation information, a holding unit, which holds the impedance of the loads which correspond to the identification information in advance, and a composite value calculation unit, which calculates the composite value of the impedance of the loads by referencing the holding unit based on the received identification information, are further provided, and the power calculation unit calculates the electrical power which is to be distributed with regard to the region based on the calculated composite value.

(21) The power distribution control device described in (20) where the holding unit holds the impedance of the loads which are operated using an operation mode in advance so that the identification information of the loads and the mode information which shows the operation mode of the loads correspond, the reception unit receives the identification information and the mode information as the calculation information, and the composite value calculation unit calculates the composite value of the impedance of the loads by referencing the holding unit based on the received identification information and mode information.

(22) The power distribution control device described in (15) to (21) where the power distribution control unit performs power distribution with regard to the region by controlling at least one of a transformer which transforms the voltage of the voltage when distributing power to the region and an reactive electrical power control device which controls reactive electrical power when distributing power to the region, based on the calculated electrical power.

(23) A power distribution control method of a power distribution control device, which controls power distribution with regard to a region which is a power distribution target, includes receiving calculation information for calculating electrical power which is to be distributed to the region from a communication device which communicates with the power distribution control device, calculating the electrical power which is to be distributed to the region based on the received calculation information, and performing power distribution with regard to the region based on the calculated electrical power, using the power distribution control device.

(24) A program for making a computer, which is a power distribution control device which controls power distribution with regard to a region which is a power distribution target, function as a reception unit which receives calculation information for calculating electrical power which is to be distributed to the region from a communication device which communicates with the power distribution control device, a power calculation unit which calculates the electrical power which is to be distributed to the region based on the received calculation information, and a power distribution control unit which performs power distribution with regard to the region based on the calculated electrical power.

(25) A power distribution control system which is configured from a power distribution control device which controls power distribution with regard to a region which is a power distribution target and a communication device which communicates with the power distribution control device, where the communication device includes an acquisition unit which acquires calculation information for calculating electrical power which is to be distributed with regard to the region and a transmission unit which transmits the calculation information to the power distribution control device, and where the power distribution control device includes a reception unit which receives calculation information for calculating electrical power which is to be distributed to the region from the communication device, an power calculation unit which calculates the electrical power which is to be distributed to the region based on the received calculation information, and a power distribution control unit which performs power distribution with regard to the region based on the calculated electrical power.

Here, the series of processes described above are able to be executed using hardware or are able to be executed using software. In the case where the series of processes is executed using software, a program which configures the software is installed from a program recording medium in a computer where specialized hardware is built in, or, for example, a typical personal computer or the like which is able to execute various types of functions by installing various types of programs.

[Computer Configuration Example]

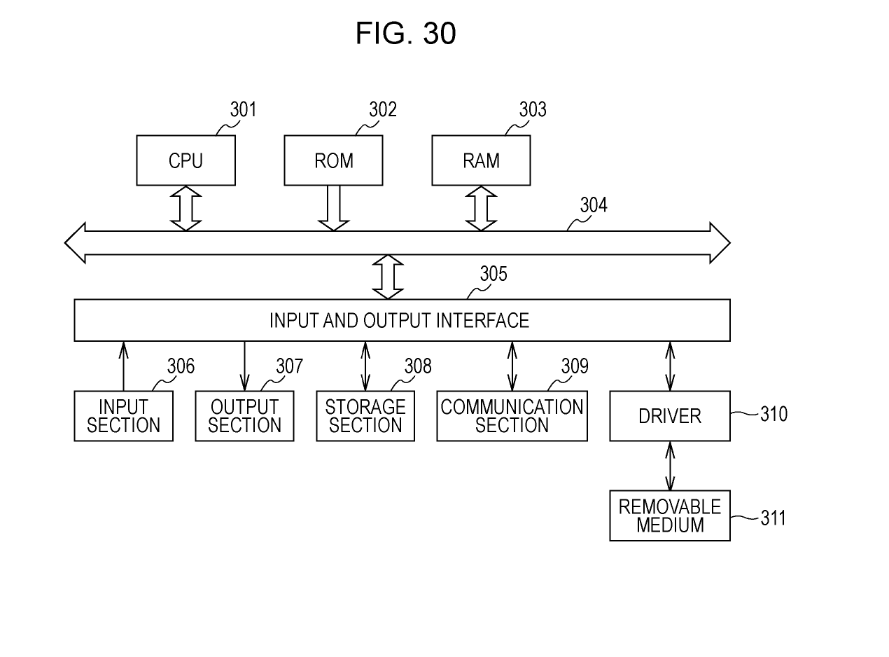

FIG. 30 is a block diagram illustrating a configuration example of computer hardware which executes the series of processes described above using a program.

In the computer, a CPU (Central Processing Unit) 301, a ROM (Read Only Memory) 302 and a RAM (Random Access Memory) 303 are connected to each other by a bus 304.

An input and output interface 305 is connected to the bus 304. The input and output interface 305 is connected to an input unit 306 which is formed by a keyboard, a mouse, a microphone or the like, an output unit 307 which is formed by a display, a speaker or the like, a storage unit 308 which is formed by a hard disk, a nonvolatile memory or the like, a communication unit 309 which is formed by a network interface or the like, and a driver 310 which drives a removable media 311 such as a magnetic disc, an optical disc, a magnetic optical disc or a semiconductor memory.

In the computer configured as above, the series of processes described above is performed by the CPU 301 executing loading of a program stored in, for example, the storage unit 308 in the RAM 303 via the input and output interface 305 and the bus 304.

Here, the program executed by the computer may be a program which performs processes in a time series in the sequence described in the specifications or may be a program which performs processing in parallel or at a necessary timing such as when a request is performed.

In addition, the program may process using one computer or may process in a dispersed manner using a plurality of computers. Furthermore, the program may be executed by being transferred to a remote computer.

In addition, in the specifications, a system represents an entire device which is configured by a plurality of devices.

Here, the embodiments of the disclosure are not limited to the embodiments described above and various modifications are possible within a range which does not depart from the concept of the disclosure.

It should be understood by those skilled in the art that various modifications, combinations, sub-combinations and alterations may occur depending on design requirements and other factors insofar as they are within the scope of the appended claims or the equivalents thereof.

What is claimed is:

1. A communication device, which communicates with a power distribution control device which controls power distribution with regard to a region which is a power distribution target, comprising:
an acquisition unit which acquires calculation information for calculating electrical power which is to be distributed with regard to the region; and
a transmission unit which transmits the calculation information to the power distribution control device.

2. The communication device according to claim 1,
wherein the acquisition unit calculates and acquires a composite value of impedance of a load which consumes electrical power in a predetermined space which is provided in a region as the calculation information, and
the transmission unit transmits the composite value to the power distribution control device.

3. The communication device according to claim 2,
wherein the acquisition unit calculates a composite value of impedance of a load which has its power on out of a plurality of loads which exist in the predetermined space and calculates the composite value using the impedance obtained based on an operation mode of the load with regard to loads where the impedance changes in accordance with the operation of the load.

4. The communication device according to claim 3,
wherein, in a case where a function which expresses the AC current flowing in the load changes over a predetermined cycle, the acquisition unit calculates the impedance of the load for each AC current which is expressed using the same function and calculates the composite value using the calculated plurality of impedances.

5. The communication device according to claim 2, further comprising:
a determination unit which determines whether or not a user exists in the predetermined space; and
a history information holding unit which holds information on the loads in cases where the user exists in the predetermined space and information on the loads in cases where the user does not exist in the predetermined space as past history information,
wherein the acquisition unit calculates the composite value of the impedance of the loads using the history information held in the history information holding unit based on the determination result of whether or not the user exists in the predetermined space.

6. The communication device according to claim 2,
wherein the acquisition unit calculates a composite value which expresses the impedance of all of the plurality of loads using a table where the impedance of the loads correspond to each of the plurality of loads.

7. The communication device according to claim 2, further comprising:
a power source unit which generates its own power which is consumed by the load; and
a detection unit which detects the amount of electrical power of the electrical power generated by the power source unit and consumed by the load,
wherein the transmission unit transmits the composite value and the amount of electrical power to the power distribution control device.

8. The communication device according to claim 7,
wherein the power source unit is formed by at least one of a power storage unit which generates electrical power which has been stored and a power generating unit which generates electrical power by generating power.

9. The communication device according to claim 8,
wherein the power storage unit stores electrical power obtained by generating power.

10. The communication device according to claim 1,
wherein the acquisition unit acquires identification information for uniquely identifying the loads which consume electrical power in the predetermined space as the calculation information and the transmission unit transmits the identification information to the power distribution control device.

11. The communication device according to claim 10,
wherein the acquisition unit also acquires the identification information and mode information which shows an operation mode of the load as the calculation information and the transmission unit transmits the identification information and the mode information to the power distribution control device.

12. A power distribution control device, which controls power distribution with regard to a region which is a power distribution target, comprising:
a reception unit which receives calculation information for calculating electrical power which is to be distributed to the region from a communication device which communicates with the power distribution control device;
a power calculation unit which calculates the electrical power which is to be distributed to the region based on the received calculation information; and
a power distribution control unit which performs power distribution with regard to the region based on the calculated electrical power.

13. The power distribution control device according to claim 12,
wherein the power calculation unit calculates the electrical power which is to be distributed to each of a plurality of regions, and
the power distribution control unit partitions or amalgamates the regions which are power distribution targets based on the electrical power which is to be distributed to each of the plurality of regions and performs power distribution with regard to the regions after partition or amalgamation.

14. The power distribution control device according to claim 13,
wherein the reception unit receives a composite value of impedance of a load which consumes electrical power in a predetermined space which is provided in a region as the calculation information, and
the power calculation unit calculates the electrical power which is to be distributed with regard to the region based on the received composite value.

15. The power distribution control device according to claim 14,
wherein the reception unit receives an amount of electrical power which is generated by the communication device itself as the calculation information, and
the power calculation unit calculates the electrical power which is to be distributed with regard to the region based on the received composite value and the amount of electrical power.

16. The power distribution control device according to claim 13,
wherein there are loads which consume electrical power in the predetermined space provided in the region,
a history information holding unit, which holds information on the loads in cases where a user exists in the predetermined space and information on the loads in cases where a user does not exist in the predetermined space as past history information, is further provided,
the reception unit receives location information which shows whether or not the user exists in the predetermined space, and
the power calculation unit calculates the electrical power which is to be distributed with regard to the region using the history information which is held by the history information holding unit based on the received location information.

17. The power distribution control device according to claim 13,
wherein the reception unit receives identification information for uniquely identifying the loads which consume electrical power in the predetermined space provided in the region as the calculation information,
a holding unit, which holds the impedance of the loads which correspond to the identification information in advance, and a composite value calculation unit, which calculates the composite value of the impedance of the loads by referencing the holding unit based on the received identification information, are further provided, and
the power calculation unit calculates the electrical power which is to be distributed with regard to the region based on the calculated composite value.

18. The power distribution control device according to claim 17,
wherein the holding unit holds the impedance of the loads which are operated using an operation mode in advance so that the identification information of the loads and the mode information which shows the operation mode of the loads correspond,
the reception unit receives the identification information and the mode information as the calculation information, and
the composite value calculation unit calculates the composite value of the impedance of the loads by referencing the holding unit based on the received identification information and mode information.

19. The power distribution control device according to claim 12,
wherein the power distribution control unit performs power distribution with regard to the region by controlling at least one of a transformer which transforms the voltage of the voltage when distributing power to the region and an reactive electrical power control device which controls reactive electrical power when distributing power to the region, based on the calculated electrical power.

20. A power distribution control system comprising:
a power distribution control device which controls power distribution with regard to a region which is a power distribution target; and
a communication device which communicates with the power distribution control device,
wherein the communication device includes an acquisition unit which acquires calculation information for calculating electrical power which is to be distributed with regard to the region and a transmission unit which transmits the calculation information to the power distribution control device, and
the power distribution control device includes a reception unit which receives calculation information for calculating electrical power which is to be distributed to the region from the communication device, an power calculation unit which calculates the electrical power which is to be distributed to the region based on the received calculation information, and a power distribution control unit which performs power distribution with regard to the region based on the calculated electrical power.
